(19) United States
(12) Patent Application Publication
(10) Pub. No.: US 2026/0120323 A1
(43) Pub. Date: Apr. 30, 2026

(54) METHOD AND APPARATUS FOR ENCODING/DECODING 3D GAUSSIAN PARAMETER AND RECORDING MEDIUM STORING BITSTREAM THEREOF

(71) Applicant: Electronics and Telecommunications Research Institute, Daejeon (KR)

(72) Inventors: Ha Hyun LEE, Daejeon (KR); Gun BANG, Daejeon (KR); Soo Woong KIM, Daejeon (KR); Jun Sik KIM, Daejeon (KR); Ji Hoon DO, Daejeon (KR); Seong Jun BAE, Daejeon (KR); Jung Won KANG, Daejeon (KR); Jin Soo CHOI, Daejeon (KR)

(73) Assignee: Electronics and Telecommunications Research Institute, Daejeon (KR)

(21) Appl. No.: 19/367,998

(22) Filed: Oct. 24, 2025

(30) Foreign Application Priority Data
Oct. 24, 2024 (KR) 10-2024-0146595
Apr. 1, 2025 (KR) 10-2025-0042347
Jun. 18, 2025 (KR) 10-2025-0080020

(51) Int. Cl. G06T 9/00; H04N 19/70

(52) U.S. Cl. CPC G06T 9/00; H04N 19/70

(57) ABSTRACT

A method for decoding Gaussian parameters, the method comprises: decoding Gaussian parameters from a bitstream; performing an inverse conversion on a color space of at least one spherical harmonic coefficient included in the decoded Gaussian parameters; performing dequantization on the Gaussian parameters; and reconstructing a Gaussian based on the dequantized Gaussian parameters, wherein the Gaussian parameters are decoded in the form of a structured two-dimensional (2D) image.

### CROSS-REFERENCE TO RELATED APPLICATIONS

This application claims the benefit of earlier filing date and right of priority to Korean Application No. 10-2024-0146595, filed on Oct. 24, 2024, Korean Application No. 10-2025-0042347, filed on Apr. 1, 2025, Korean Application No. 10-2025-0080020, filed on Jun. 18, 2025, the contents of which are all hereby incorporated by reference herein in their entirety.

### TECHNICAL FIELD

The present disclosure relates to a method and an apparatus for encoding and decoding three-dimensional (3D) Gaussian parameters and a recording medium storing a bitstream, and more particularly, to a method and an apparatus for encoding and decoding 3D Gaussian parameters based on two-dimensional (2D) image structuring, and a recording medium storing a bitstream.

### BACKGROUND

In connection with virtual reality (VR) and augmented reality (AR) technologies, various studies are actively being conducted to enhance image quality and provide a better viewing experience. In the field of image rendering, Gaussian Splatting has been developed, which receives multi-view images as input and optimizes Gaussian parameters to obtain an image from an arbitrary viewpoint, thereby enabling flexible and rich scene representation.

Gaussian splatting technology has the advantage of fast training and rendering speed, but as the scene size increases, the number of Gaussians generated during the Gaussian splatting optimization process increases significantly, which increases the overall storage space of the model.

### SUMMARY

The technical object of the present disclosure is to provide a method for encoding and decoding three-dimensional (3D) Gaussian parameters based on two-dimensional (2D) image structuring.

It is a further object of the present disclosure to provide a method for performing structuring for each Gaussian parameter.

It is a further object of the present disclosure to provide a method for grouping structured 2D images.

It is a further object of the present disclosure to provide a method for quantizing and dequantizing each Gaussian parameter.

It is a further object of the present disclosure to provide a stream structure for encoding and decoding 3D Gaussian parameters.

The features briefly summarized above regarding the present disclosure are merely exemplary aspects of the detailed description of the present disclosure that follows and do not limit the scope of the present disclosure.

In accordance with an aspect of the present disclosure, the above and other objects can be accomplished by the provision of a method for decoding Gaussian parameters, the method comprises: decoding Gaussian parameters from a bitstream; performing an inverse conversion on a color space of at least one spherical harmonic coefficient included in the decoded Gaussian parameters; performing dequantization on the Gaussian parameters; and reconstructing a Gaussian based on the dequantized Gaussian parameters, wherein the Gaussian parameters are decoded in the form of a structured two-dimensional (2D) image.

In the method for decoding the Gaussian parameters according to the present disclosure, a reordering of at least one spherical harmonic coefficient included in the decoded Gaussian parameters is further performed, and the inverse conversion is performed on the reordered at least one spherical harmonic coefficient.

In the method for decoding the Gaussian parameters according to the present disclosure, the inverse conversion is performed by setting a truncated UV coefficient among the at least one spherical harmonic coefficient to a predefined value of 0.

In the method for decoding the Gaussian parameters according to the present disclosure, the dequantization is performed by applying different dequantization methods for each Gaussian parameter.

In the method for decoding the Gaussian parameters according to the present disclosure, the dequantization on the at least one spherical harmonic coefficient included in the Gaussian parameters is performed based on the minimum and maximum values calculated for each channel for any one of the RGB, YUV, or YCbCr color spaces.

In the method for decoding the Gaussian parameters according to the present disclosure, the dequantization on the at least one spherical harmonic coefficient included in the Gaussian parameters is performed based on the minimum and maximum values calculated by integrating all channels for any one of the RGB, YUV, or YCbCr color spaces.

In the method for decoding the Gaussian parameters according to the present disclosure, the structuring is performed by storing the Gaussian parameters as pixel values of a 2D image based on a predetermined scanning order, wherein the predetermined scanning order includes at least one of a raster scan order, a reverse raster scan order, a zig-zag order, and a reverse zig-zag order.

In the method for decoding the Gaussian parameters according to the present disclosure, the structured 2D image is grouped into at least one group.

In the method for decoding the Gaussian parameters according to the present disclosure, at least one of information among a number of groups, the arrangement order of the 2D images within a group, and the Gaussian parameter type for the 2D images is decoded from the bitstream.

In the method for decoding the Gaussian parameters according to the present disclosure, based on the structured 2D images being grouped into a first group including structured 2D images for position information, a second group including structured 2D images for spherical harmonic coefficients, and a third group including structured 2D images for opacity information, unit type information is decoded from the bitstream in a Gaussian parameter unit header, based on a value of the unit type information indicating a first type related to the position information, an index indicating the position information is decoded from the bitstream, based on the value of the unit type information indicating a second type related to the spherical harmonic coefficients, an index indicating the spherical harmonic coefficients is decoded from the bitstream, and based on the value of the unit type information indicating a third type related to the opacity information, rotation information, and scale information, an index indicating at least one of the opacity information, rotation information, and scale information is decoded from the bitstream.

In accordance with an aspect of the present disclosure, the above and other objects can be accomplished by the provision of a method for encoding Gaussian parameters, the method comprises: performing pruning on Gaussians; sorting Gaussian parameters of the pruned Gaussians; performing conversion on a color space of at least one spherical harmonic coefficient included in the sorted Gaussian parameters; performing quantization on the Gaussian parameters; and encoding the quantized Gaussian parameters into a bitstream, wherein the Gaussian parameters are decoded in the form of a structured two-dimensional (2D) image.

In the method for encoding the Gaussian parameters according to the present disclosure, the quantization is performed by applying different quantization methods for each Gaussian parameter.

In the method for encoding the Gaussian parameters according to the present disclosure, the quantization on the at least one spherical harmonic coefficient included in the Gaussian parameters is performed based on the minimum and maximum values calculated for each channel for any one of the RGB, YUV, or YCbCr color spaces.

In the method for encoding the Gaussian parameters according to the present disclosure, the quantization on the at least one spherical harmonic coefficient included in the Gaussian parameters is performed based on the minimum and maximum values calculated by integrating all channels for any one of the RGB, YUV, or YCbCr color spaces.

In the method for encoding the Gaussian parameters according to the present disclosure, the structuring is performed by storing the Gaussian parameters as pixel values of a 2D image based on a predetermined scanning order, wherein the predetermined scanning order includes at least one of a raster scan order, a reverse raster scan order, a zig-zag order, and a reverse zig-zag order.

In the method for encoding the Gaussian parameters according to the present disclosure, the structured 2D image is grouped into at least one group.

In the method for encoding the Gaussian parameters according to the present disclosure, the grouping is performed based on at least one of information among a number of groups, the arrangement order of the 2D images within a group, and the Gaussian parameter type for the 2D images.

In the method for encoding the Gaussian parameters according to the present disclosure, based on the structured 2D images being grouped into a first group including a structured 2D image for position information, a second group including a structured 2D image for spherical harmonic coefficients, and a third group including a structured 2D image for opacity information, rotation information, and scale information, unit type information is encoded into the bitstream and transmitted in a Gaussian parameter unit header, based on a value of the unit type information indicating a first type related to the position information, an index indicating the position information is encoded into the bitstream and transmitted, based on the value of the unit type information indicating a second type related to the spherical harmonic coefficients, an index indicating the spherical harmonic coefficients is encoded into the bitstream and transmitted, and based on the value of the unit type information indicating a third type related to the opacity information, rotation information, and scale information, an index indicating at least one of the opacity information, rotation information, and scale information is encoded into the bitstream and transmitted.

A recording medium for storing a bitstream generated by a method for encoding Gaussian parameters according to the present disclosure is provided.

The technical problems to be achieved in the present disclosure are not limited to the technical problems mentioned above, and other technical problems not mentioned herein may be clearly understood by those skilled in the art from the description below.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram illustrating a process of Gaussian generation, Gaussian parameter optimization, and rendering according to one embodiment of the present disclosure.

FIG. 2 is a flowchart for explaining a method of encoding Gaussian parameters based on two-dimensional image structuring according to one embodiment of the present disclosure.

FIG. 3 is a drawing illustrating, as an example according to the present disclosure, an arrangement order of spherical harmonic coefficients in an RGB color space.

FIG. 4 is a diagram illustrating as an example according to the present disclosure, a result of reordering the spherical harmonic coefficients in an RGB color space.

FIG. 5 is a diagram illustrating, as an embodiment according to the present disclosure, spherical harmonic coefficients performed conversion from an RGB color space to a YUV color space.

FIG. 6 is diagram illustrating, as an embodiment according to the present disclosure, a result of reordering spherical harmonic coefficients converted into a YUV color space.

FIG. 7 is a diagram illustrating, as an embodiment according to the present disclosure, an example of grouped two-dimensional images according to one embodiment of the present disclosure.

FIG. 8 is a diagram illustrating, according to the present disclosure, an embodiment of encoding Gaussian parameters based on two-dimensional image structuring.

FIG. 9 is a diagram illustrating, as an embodiment according to the present disclosure, a 3DGS encoding stream structure.

FIG. 10 is a diagram illustrating, as an embodiment according to the present disclosure, a 3DGS encoding stream structure in a case where 2D images are grouped.

FIG. 11 is a diagram illustrating, as an embodiment according to the present disclosure, a 3DGS encoding stream structure in a case where 2D images are grouped.

FIG. 12 is a flowchart for explaining a method of decoding Gaussian parameters based on two-dimensional image structuring according to an embodiment of the present disclosure.

FIG. 13 is a diagram illustrating, according to the present disclosure, an embodiment of encoding and decoding structured 2D images.

FIG. 14 is a diagram illustrating, according to the present disclosure, an embodiment of reconstructing Gaussian parameters and generating arbitrary viewpoints based on structured 2D images.

FIG. 15 is a block diagram of an encoding apparatus for performing a method of encoding Gaussian parameters based on 2D image structuring according to an embodiment of the present disclosure.

FIG. 16 is a block diagram of a decoding apparatus for performing a method of decoding Gaussian parameters based on 2D image structuring according to an embodiment of the present disclosure.

FIG. 17 is a diagram illustrating an apparatus for performing a method of encoding and decoding Gaussian parameters based on 2D image structuring according to the present disclosure.

### DETAILED DESCRIPTION OF THE INVENTION

Since the present disclosure may be variously changed and have several embodiments, specific embodiments are illustrated in drawings and are described in detail in a detailed description. However, this is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but do not need to be mutually exclusive. For example, a specific shape, structure and characteristic described herein may be implemented in other embodiments without departing from a scope and a spirit of the present disclosure in connection with an embodiment. In addition, it should be understood that a position or arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, terms such as first, second, etc. may be used to describe a variety of elements, but the elements should not be limited by the terms. The terms are used only to distinguish one element from another element. For example, without departing from a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that the element may be directly connected or linked to that another element, but there may be another element therebetween. Meanwhile, when an element is referred to as being “directly connected” or “directly linked” to another element, it should be understood that there is no other element therebetween.

As construction units shown in an embodiment of the present disclosure are independently shown to represent different characteristic functions, it does not mean that each construction unit is composed in a construction unit of separate hardware or one piece of software. In other words, as each construction unit is included by being enumerated as each construction unit for convenience of a description, at least two construction units of each construction unit may be combined to form one construction unit or one construction unit may be subdivided into a plurality of construction units to perform a function, and an integrated embodiment and a separate embodiment of each construction unit are also included in a scope of a right of the present disclosure unless they are beyond the essence of the present disclosure.

A term used in the present disclosure is merely used to describe a specific embodiment, and is not intended to limit the present disclosure. A singular expression, unless the context clearly indicates otherwise, includes a plural expression. In the present disclosure, it should be understood that a term such as “include” or “have”, etc. is merely intended to designate the presence of a feature, a number, a step, an operation, an element, a part or a combination thereof described in the present specification, and does not preclude a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not necessary elements which perform an essential function in the present disclosure and may be optional elements for merely improving performance. The present disclosure may be implemented by including only a construction unit which is necessary to implement essence of the present disclosure except for an element merely used for performance improvement, and a structure including only a necessary element except for an optional element merely used for performance improvement is also included in a scope of a right of the present disclosure.

Hereinafter, an embodiment of the present disclosure is described in detail by referring to the drawings. In describing an embodiment of the present specification, when it is determined that a detailed description on a relevant disclosed configuration or function may obscure a gist of the present specification, such a detailed description is omitted, and the same reference numeral is used for the same element in the drawings and an overlapping description on the same element is omitted.

First, the terms used in this application are briefly explained as follows.

A Gaussian may represent a probability distribution that describes how data is distributed in 3D space, indicating how densely data points are clustered within a specific region—that is, the data density. The Gaussian may be defined by a mean vector and a covariance matrix.

Splatting, or Gaussian Splatting, may refer to a technique for generating a two-dimensional (2D) image by learning a three-dimensional (3D) space of a specific scene. Since it enables generation of a 2D image corresponding to a desired viewpoint of a user, Gaussian Splatting may belong to the field of novel-view synthesis.

Pruning, or Gaussian Pruning, may refer to removing or ignoring some Gaussians among multiple Gaussians that have a low contribution or low importance.

Hereinafter, embodiments of the present invention will be described in more detail with reference to the accompanying drawings.

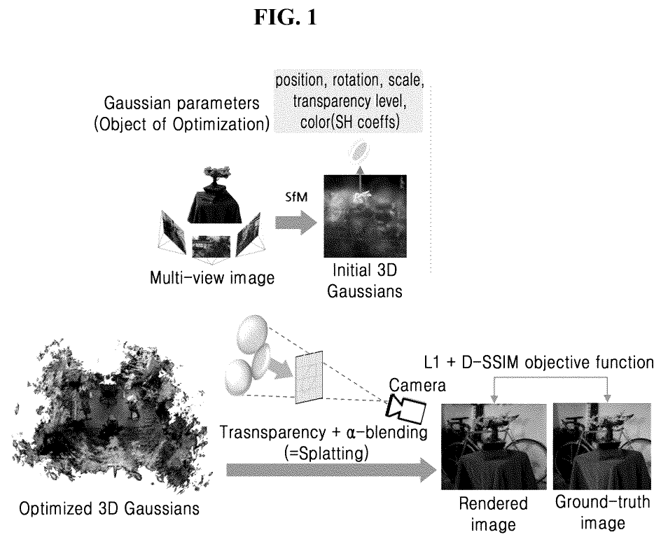

FIG. 1 is a diagram illustrating a process of Gaussian generation, Gaussian parameter optimization, and rendering according to one embodiment of the present disclosure.

When multi-view images captured from at least two viewpoints are input, initial Gaussians may be generated using Structure from Motion (SfM). SfM may refer to a technique for simultaneously estimating a 3D structure of a captured scene and the motion of a camera.

Meanwhile, Gaussians may be generated based on Gaussian parameters. For example, a Gaussian may be represented by Gaussian parameters such as position, rotation information, scale information, opacity information, and spherical harmonic coefficients. The spherical harmonic coefficients may represent information for expressing a color (or color value) of the Gaussian. The Gaussian parameters may also be understood as parameters interchangeably.

For example, position information of a Gaussian may be represented by three pieces of information. The position information may be expressed as (x, y, z).

For example, rotation information of a Gaussian may be represented by four quaternions. The rotation information may be expressed as (w, x, y, z).

For example, scale information of a Gaussian may be represented by three pieces of information. The scale information may be expressed as (Sₓ, S_{y}, S_{z}).

For example, opacity information of a Gaussian may be represented by one piece of information. The opacity information may be expressed as a.

For example, spherical harmonic coefficients of a Gaussian may be represented by 48 spherical harmonic coefficients. The spherical harmonic coefficients may include DC spherical harmonic coefficients and/or AC spherical harmonic coefficients. For instance, the color may be represented by three DC spherical harmonic coefficients and 45 AC spherical harmonic coefficients.

However, the disclosed numerical values are merely examples and may have different values.

The generated 3D Gaussians may be projected onto a 2D image and rendered. By comparing the projected image with a ground-truth image, a loss may be calculated, and, for example, an L1 loss function and a D-SSIM loss function may be used. Based on the calculated loss value, optimization may be performed by adaptively controlling the Gaussian parameters.

In addition, during the optimization process of the Gaussian parameters, the number of Gaussians may be increased or decreased to precisely represent a scene or to remove unnecessary parts.

The optimized Gaussians may be projected onto a 2D image, and tile rasterization may be performed on the projected image. Subsequently, alpha blending (α-blending) may be performed in a depth order, that is, starting from the Gaussian closest to the screen, to generate a finally rendered image.

By comparing the finally rendered image with a ground-truth image using an L1 loss function and a D-SSIM (Differential Structural Similarity) function, the consistency of the Gaussian Splatting method may be verified.

The Gaussian Splatting has an advantage of faster training and rendering speeds compared to Neural Radiance Fields (NeRF), which is a technique belonging to novel-view synthesis. However, as the size of a scene increases, the number of Gaussians generated during the optimization process of the Gaussian parameters may significantly increase, which may cause an increase in storage space required for the Gaussian model. Accordingly, the present disclosure proposes a method for encoding and decoding Gaussian parameters based on 2D image structuring. According to the method proposed in the present disclosure, Gaussian parameters may be compressed and reconstructed with a small data size, thereby achieving the effect of generating a novel view having the same image quality.

Hereinafter, a method for encoding/decoding Gaussian parameters according to the present disclosure will be described in detail.

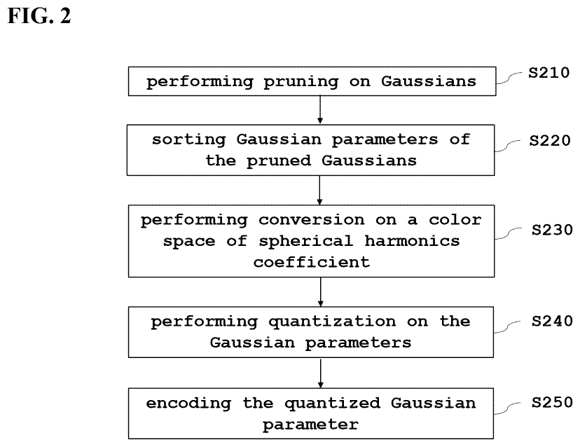

FIG. 2 is a flowchart for explaining a method of encoding Gaussian parameters based on two-dimensional image structuring according to one embodiment of the present disclosure.

Referring to FIG. 2, pruning is performed on Gaussians S210.

According to one embodiment of the present disclosure, pruning may be performed on Gaussians based on Gaussian opacity information.

For example, after sorting the opacity information of the Gaussians, pruning for the Gaussians may be performed. As a result of the pruning, the lower M % of the Gaussians may be removed, where M may be an integer greater than 0.

According to one embodiment of the present disclosure, pruning of Gaussians may be performed based on importance information of the Gaussians. The importance information may be calculated as shown in the following Mathematical equation 1.

$${GS}_{j} = {\sum }_{i = 1}^{MHW} 𝕀 ( G ( {X}_{j} ) , {r}_{i} ) \cdot {σ}_{j} \cdot γ ( {\sum }_{j} ) \qquad [ Mathematical equation 1 ]$$

Here, j may represent the Gaussian index, M may represent the number of image views used for training, H may represent the vertical size of the image, W may represent the horizontal size of the image, and i may represent the pixel index.

The importance of Gaussians may be calculated for all training images based on whether the Gaussian is transparent to the image. Whether the Gaussian is transparent to the image may be calculated using Mathematical equation 2.

$$𝕀 ( G ( {X}_{j} ) , {r}_{i} ) \qquad [ Mathematical equation 2 ]$$

Referring to Mathematical equation 1, importance information of a Gaussian may be calculated by considering opacity information and a volume of the Gaussian.

The pruning may be repeatedly performed. After the pruning is performed, fine-tuning may be performed. The fine-tuning is a process of slightly adjusting the Gaussian parameters to improve performance. It may help restore information lost after pruning and optimize the Gaussians.

Referring to FIG. 2, Gaussian parameters of the pruned Gaussians are sorted S220.

According to one embodiment of the present disclosure, sorting or Gaussian sorting may be performed based on specific Gaussian parameters.

For example, sorting may be performed based on the position information of Gaussians and the DC spherical harmonic coefficients. In this case, the remaining Gaussian parameters, excluding the above parameters, may be sorted identically to match the position of the reference Gaussian parameter.

However, the Gaussian parameters disclosed above are merely examples, and the sorting process may be performed based on different Gaussian parameters.

According to one embodiment of the present disclosure, sorting may be performed using a self-organizing map.

Referring to FIG. 2, conversion on a color space of at least one spherical harmonic coefficient included in the sorted Gaussian parameters is performed S230.

The Gaussian parameters sorted in S220 may include one or more spherical harmonic coefficients. Spherical harmonic coefficients may be represented in an RGB color space.

According to one embodiment of the present disclosure, spherical harmonic coefficients represented in the RGB color space may be converted and represented in the YUV color space.

The conversion may be performed using a conversion matrix.

For example, the conversion matrix may be expressed as in the following Mathematical equation 3.

$$[ \begin{matrix}Y \\ U \\ V\end{matrix} ] = [ \begin{matrix}0.299 & + 0.587 & + 0.114 \\ - 0.14713 & - 0.28886 & 0.436 \\ + 0.615 & - 0.51498 & - 0.10001\end{matrix} ] [ \begin{matrix}R \\ G \\ B\end{matrix} ] \qquad [ Mathematical equation 3 ]$$

The Mathematical equation 3 may be an expression defined in the BT. 470 document.

According to one embodiment of the present disclosure, information regarding whether a color space is converted and the converted color space may be encoded into a bitstream and transmitted.

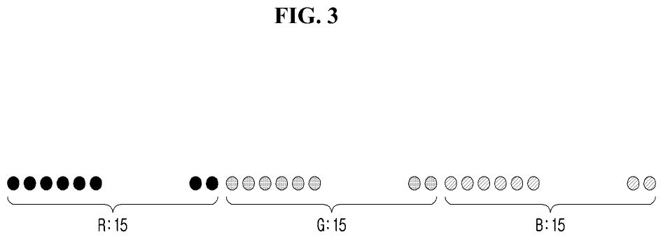

Meanwhile, FIG. 3 is a drawing illustrating, as an example according to the present disclosure, an arrangement order of spherical harmonic coefficients in an RGB color space.

The spherical harmonic coefficients may be arranged separately for each channel in an RGB color space.

Referring to FIG. 3, the spherical harmonic coefficients may be arranged in the order of an R channel, a G channel, and a B channel. That is, the spherical harmonic coefficients may be stored by being divided into R coefficients, G coefficients, and B coefficients. Specifically, for 45 AC spherical harmonic coefficients, they may be arranged in the order of 15 R coefficients, 15 G coefficients, and 15 B coefficients.

However, the described numerical values are merely examples and may have different values.

As illustrated in FIG. 3, the spherical harmonic coefficients may be arranged, stored, and encoded by channel.

Alternatively, the spherical harmonic coefficients may be reordered prior to the conversion. This reordering may make the conversion easier.

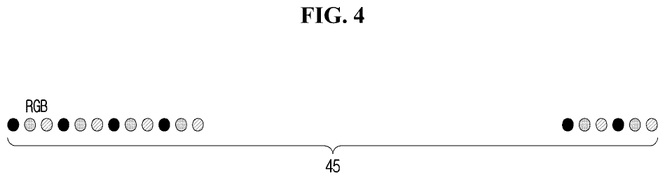

FIG. 4 is a diagram illustrating as an example according to the present disclosure, a result of reordering the spherical harmonic coefficients in an RGB color space.

According to one embodiment of the present disclosure, when performing reordering, the spherical harmonic coefficients may be sequentially arranged for each channel in the RGB color space.

Referring to FIG. 4, the R coefficients, G coefficients, and B coefficients may be arranged alternately for the spherical harmonic coefficients.

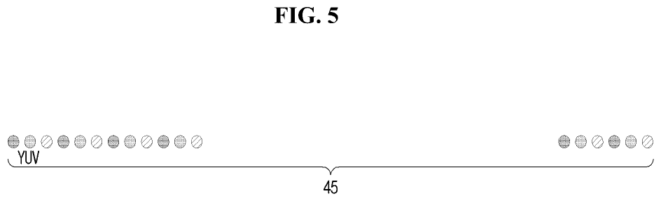

FIG. 5 is a diagram illustrating, as an embodiment according to the present disclosure, spherical harmonic coefficients performed conversion from an RGB color space to a YUV color space.

Referring to FIG. 5, as a result of converting the spherical harmonic coefficients, the coefficients of the Y channel, the coefficients of the U channel, and the coefficients of the V channel may be arranged alternately.

Meanwhile, according to one embodiment of the present disclosure, additional reordering may be performed on the spherical harmonic coefficients of the YUV color space.

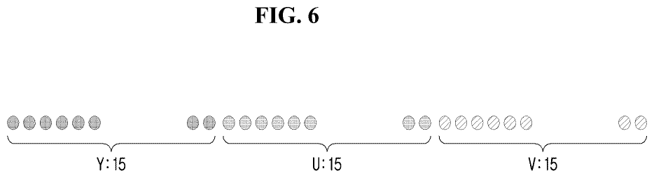

FIG. 6 is diagram illustrating, as an embodiment according to the present disclosure, a result of reordering spherical harmonic coefficients converted into a YUV color space.

Referring to FIG. 6, the AC spherical harmonic coefficients may be arranged in the order of Y channel, U channel, and V channel. That is, the AC spherical harmonic coefficients may be divided into Y coefficients, U coefficients, and V coefficients and stored. Specifically, for 45 AC spherical harmonic coefficients, they may be arranged in the order of 15 Y coefficients, 15 U coefficients, and 15 V coefficients.

However, the described numerical values are merely examples and may have different values.

According to an embodiment of the present disclosure, as illustrated in FIG. 6, when the coefficients are arranged and stored by being divided for each channel in a YUV color space, they may be reordered so as to be sequentially arranged for each channel in the YUV color space, as illustrated in FIG. 5. Subsequently, in a decoding process, an inverse conversion into an RGB color space may be performed on the reordered coefficients. As illustrated in FIG. 4, the inverse-converted coefficients may be sequentially arranged for each channel in the RGB color space. Additionally, as illustrated in FIG. 3, a reordering process may be performed so that the spherical harmonic coefficients are arranged separately for each channel in the RGB color space.

When using spherical harmonic coefficients in the YUV color space, additional truncation may be performed on some spherical harmonic coefficients. The truncation may improve encoding efficiency.

Referring to FIG. 2, quantization may be performed on Gaussian parameters S240.

According to one embodiment of the present disclosure, quantization may be performed based on the minimum and maximum values of Gaussian parameters.

Quantization may be performed by calculating the following Mathematical equation 4.

$${x}_{norm} = \frac{x - {x}_{min}}{{x}_{max} - {x}_{min}} \qquad [ Mathematical equation 4 ]$$

$${x}_{q} = round ( {x}_{norm} \times ( L - 1 ) )$$

$${x}_{recon} = {x}_{q} \times \frac{{x}_{max} - {x}_{min}}{L - 1} + {x}_{min}$$

Here, x may represent the Gaussian parameter value of a Specific Gaussian, xₘₐₓ may represent the maximum value of the Gaussian parameter x calculated for all Gaussians, xₘᵢₙ may represent the minimum value of the Gaussian parameter x calculated for all Gaussians, and xₙₒᵣₘ may represent the normalized value of the Gaussian parameter x. In addition, L may represent the number of integer bits represented by the quantization result, and x_{q} may represent the quantized value.

The variable x is merely an example for convenience of explanation and may be understood to apply to all Gaussian parameters.

As a result of performing quantization by calculating Mathematical equation 4, the Gaussian parameters may be represented in integer bits.

For example, a parameter X corresponding to position information may be represented with L integer bits.

For example, a parameter Y corresponding to position information may be represented with M integer bits.

For example, a parameter Z corresponding to position information may be represented with N integer bits.

For example, a parameter W corresponding to rotation information may be represented with O integer bits.

For example, a parameter Sₓ corresponding to scale information may be represented with P integer bits.

Here, L, M, N, O, and P may be the same integer value or different integer values. The parameters corresponding to the position information may be represented with the same number of integer bits, or the position information and the rotation information may be represented with different numbers of integer bits. Specifically, L, M, N, O, and P may be any one of 8, 12, or 16.

When quantization is performed based on minimum and maximum values, information on the minimum and maximum values for each Gaussian parameter for performing dequantization may be encoded into the bitstream and transmitted.

Meanwhile, according to an embodiment of the present disclosure, the same quantization method may be applied to each Gaussian parameter, or different quantization methods may be applied.

For example, quantization of position information may be performed by calculating Mathematical equation 5.

$${x}_{q} = f ( \frac{x - {x}_{min}}{256} , {b}_{pos} ) \qquad [ Mathematical equation 5 ]$$

$${y}_{q} = f ( \frac{y - {y}_{min}}{256} , {b}_{pos} )$$

$${z}_{q} = f ( \frac{z - {z}_{min}}{256} , {b}_{pos} )$$

Here, bₚₒₛ may denote a quantization bit for position information, xₘᵢₙ may denote a minimum value of a Gaussian parameter x calculated for all Gaussians, yₘᵢₙ may denote a minimum value of a Gaussian parameter y calculated for all Gaussians, and zₘᵢₙ may denote a minimum value of a Gaussian parameter z calculated for all Gaussians. Here, bₚₒₛ may be an integer greater than 0.

For example, quantization of opacity information may be performed by calculating Equation 6.

$${op}_{q} = f ( \frac{op + N}{M} , {b}_{op} ) \qquad [ Mathematical Equation 6 ]$$

Here, bₒₚ may denote a quantization bit for opacity information. Here, N and M may be integers greater than 0. For example, N may be 7, and M may be 25.

For example, quantization of scale information may be performed by calculating Mathematical equation 7.

$${s}_{q} = f ( \frac{s + P}{Q} , {b}_{s} ) \qquad [ Mathematical equation 7 ]$$

Here, bₑ may denote a quantization bit for scale information. Here, P and Q may be integers greater than 0. For example, P may be 26, and Q may be 30.

For example, quantization of rotation information may be performed by calculating Mathematical equation 8.

$${r}_{q} = f ( \frac{r + C}{V} , {b}_{r o} ) \qquad [ Mathematical equation 8 ]$$

Here, r may denote normalized rotation information, and bᵣₒₜ may denote a quantization bit for rotation information. Here, C and V may be integers greater than 0. For example, C may be 1, and V may be 2.

Normalization may be performed for rotation information before quantization. In this case, when a parameter w corresponding to the rotation information is negative, its sign may be inverted to make it positive.

For example, quantization of spherical harmonic coefficients may be performed by calculating Mathematical equation 9.

$${c}_{q} = f ( \frac{c}{2 Δ} + \frac{1}{2} , {b}_{s h} ) \qquad [ Mathematical equation 9 ]$$

In Mathematical equation 9, c may represent spherical harmonic coefficients represented in the YUV color space, and bₛₕ may represent a quantization bit for the spherical harmonic coefficients. Here, bₛₕ and Δ may be integers greater than 0. For example, they may be 4.

Meanwhile, the function f used in the above Mathematical equations 5 to 9 may be defined as in the following Mathematical equation 10.

$$f ( x , b ) = \{ \begin{matrix}0 , & if x \leq 0 \\ {2}^{b} - 1 , & if x \times {2}^{b} \geq {2}^{b} - 1 \\ round ( x \times {2}^{b} ) , & otherwise\end{matrix} \qquad [ Mathematical equation 10 ]$$

Here, the independent variables of the function f may vary depending on the Gaussian parameters being quantized.

Meanwhile, quantization of the Gaussian parameters may also be performed as described in the following example.

For example, quantization may be performed on each RGB, YUV, or YCbCr channel by calculating the above Mathematical equation 4 based on the minimum and maximum values calculated for each RGB, YUV, or YCbCr channel for the DC components corresponding to level 0 among the spherical harmonic coefficients represented in the RGB, YUV, or YCbCr color space. The minimum and maximum values for each channel for the DC components may be transmitted by being included in the bitstream.

For example, quantization may be performed on each channel of RGB, YUV, or YCbCr by calculating the above Mathematical equation 4 based on the minimum and maximum values calculated by integrating all RGB or YUV channels for the DC components corresponding to level 0 among the spherical harmonic coefficients represented in the RGB, YUV, or YCbCr color space. The minimum and maximum values for each channel for the DC components may be transmitted by being included in the bitstream.

For example, for AC components corresponding to levels greater than level 0 among the spherical harmonic coefficients represented in an RGB, YUV, or YCbCr color space, quantization may be performed for each channel of the RGB, YUV, YCbCr color space by calculating the above Mathematical equation 4 based on minimum and maximum values calculated for each channel of the RGB, YUV, or YCbCr color space. The minimum and maximum values for each channel of the AC components may be included in the bitstream and transmitted.

For example, for AC components corresponding to levels greater than level 0 among the spherical harmonic coefficients represented in an RGB, YUV, or YCbCr color space, quantization may be performed for each channel of the RGB, YUV, or YCbCr color space by calculating the above Mathematical equation 4 based on minimum and maximum values calculated by integrating all channels of the RGB, YUV, or YCbCr color space. The minimum and maximum values for each channel of the AC components may be included in the bitstream and transmitted.

For example, for the spherical harmonic coefficients represented in an RGB, YUV, or YCbCr color space, quantization on each channel of the RGB, YUV, or YCbCr color space may be performed by calculating the above Mathematical equation 4 based on minimum and maximum values calculated by integrating all channels. In this embodiment, a single minimum and a single maximum value may be applied to the spherical harmonic coefficients, and the minimum and maximum values may be included in the bitstream and transmitted.

For example, quantization with a fixed normalization range may be performed by calculating the above Mathematical equation 9 for AC components corresponding to levels greater than level 0 among the spherical harmonic coefficients expressed in the RGB or YUV or YCbCr color space. In this embodiment, information on the fixed normalization range value may be included in the bitstream and transmitted. Alternatively, the same range value as that used in a preprocessing stage may be defined in a post-processing.

For example, quantization on each of 3D spatial scale information components X, Y, and Z of a Gaussian may be performed by calculating the above Mathematical equation 4 based on minimum and maximum values calculated by integrating the X, Y, and Z components of the 3D spatial scale information.

For example, quantization on each of 3D spatial rotation information components X, Y, Z, and W of a Gaussian may be performed by calculating the above Mathematical equation 4 based on minimum and maximum values calculated by integrating X, Y, Z, and W components of the 3D spatial rotation information. Before the quantization process, normalization may be performed for the Gaussian rotation information, and in particular, a sign of a parameter W may be inverted to make it positive.

For example, quantization on each of 3D spatial position information components X, Y, and Z of a Gaussian may be performed by calculating the above Mathematical equation 4 based on minimum and maximum values calculated by integrating the X, Y, and Z components of the 3D spatial position information.

For example, for DC components corresponding to level 0 among the spherical harmonic coefficients represented in an RGB, YUV, or YCbCr color space, quantization may be performed for each color channel (R, G, B or Y, U, V, or Y, Cb, Cr) by calculating the above Mathematical equation 4 after calculating at least one of a minimum value and a maximum value for each channel.

In this case, if only the minimum value is calculated, the maximum value may be derived by adding a predefined offset value to the minimum value. Conversely, if only the maximum value is calculated, the minimum value may be derived by subtracting the offset value from the maximum value.

At least one of the minimum value, maximum value, and offset value for the DC component may be included in the bitstream and transmitted for each channel.

For example, for AC components corresponding to levels greater than level 0 among the spherical harmonic coefficients represented in an RGB, YUV, or YCbCr color space, quantization may be performed for each color channel (R, G, B or Y, U, V or Y, Cb, Cr) by calculating the above Mathematical equation 4 after calculating at least one of a minimum value and a maximum value for each color channel.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum value, the maximum value, and the offset value for the AC components may be included in the bitstream and transmitted for each channel.

For example, for DC components corresponding to level 0 among the spherical harmonic coefficients represented in an RGB, YUV, or YCbCr color space, quantization may be performed for each color channel (R, G, B or Y, U, V or Y, Cb, Cr) by calculating at least one of a minimum value and a maximum value after integrating the color channels, and using at least one of the calculated minimum or maximum values according to the above Mathematical equation 4.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum values, the maximum value, or the offset value for the DC components may be included in the bitstream and transmitted for each channel.

For example, for AC components corresponding to levels greater than level 0 among the spherical harmonic coefficients represented in an RGB, YUV, or YCbCr color space, quantization may be performed for each color channel (R, G, B or Y, U, V or Y, Cb, Cr) according to the above Mathematical equation 4 by calculating at least one of a minimum value and a maximum value after integrating the color channels, and using at least one of the calculated minimum or maximum values.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum values, the maximum value, or the offset value for the AC components may be included in the bitstream and transmitted for each channel.

For example, quantization may be performed on each of the 3D spatial scale information X, Y, and Z according to the above Mathematical equation 4 by using at least one of the minimum or maximum values calculated by integrating the 3D spatial scale information X, Y, and Z components of Gaussian.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum value, maximum value, or offset value for the above 3D spatial scale information may be transmitted by being included in the bitstream for each channel.

For example, quantization may be performed on each of the 3D spatial rotation information X, Y, Z, and W according to the above Mathematical equation 4 by using at least one of the minimum or maximum values calculated by integrating the 3D spatial rotation information X, Y, Z, and W components of Gaussian. Prior to the quantization process, normalization may be performed on the Gaussian rotation information, and in particular, the sign of parameter W may be changed to a positive value.

At least one of the minimum value, maximum value, or offset value for the above 3D spatial rotation information may be transmitted by being included in the bitstream for each channel.

Referring to FIG. 2, the quantized Gaussian parameters are encoded into a bitstream S250.

According to one embodiment of the present disclosure, quantized Gaussian parameters may be structured and encoded as a 2D image.

Hereinafter, the 2D image structuring method proposed in the present disclosure will be described.

### Structuring Gaussian Parameters

The quantized Gaussian parameter values may be represented in a one-dimensional (1D) array form. In this case, the Gaussian parameter values represented in the 1D array form may be structured into a 2D planar image.

According to an embodiment of the present disclosure, the Gaussian parameter values may be structured into a 2D planar image based on a predetermined scanning order.

For example, the quantized Gaussian parameter values may be stored as pixel values based on a raster scanning order with reference to the upper-left corner of the 2D plane.

For example, the quantized Gaussian parameter values may be stored as pixel values based on a reverse raster scanning order with reference to the upper-right corner of the 2D plane.

For example, the quantized Gaussian parameter values may be stored as pixel values based on a zigzag scanning order with reference to the upper-left corner of the 2D plane.

For example, the quantized Gaussian parameter values may be stored as pixel values based on a reverse zigzag scanning order with reference to the lower-right corner of the 2D plane.

The structuring may be performed by applying the same scanning order to all Gaussian parameters, or by applying different scanning orders to each Gaussian parameter.

For example, for parameters X, Y, and Z corresponding to position information, the structuring may be performed by applying a raster scanning order with reference to the upper-left corner.

For example, for a parameter W corresponding to rotation information, the structuring may be performed by applying a zigzag scanning order with reference to the upper-left corner.

Information on a scanning method may be predefined in an encoding apparatus and a decoding apparatus. Alternatively, information on the scanning method may be encoded into the bitstream and transmitted from the encoding apparatus to the decoding apparatus. In a decoding process, the Gaussian parameters in a 1D array form may be reconstructed based on predefined information or the transmitted information.

According to one embodiment of the present disclosure, structuring may be omitted for at least one Gaussian parameter. For example, structuring may be omitted for at least one UV coefficient among the spherical harmonic coefficients converted form the RGB color space to the YUV color space.

According to one embodiment of the present disclosure, as a result of performing structuring, a 2D image having a predetermined format may be generated.

For example, a 2D image having a single (monochrome or YUV 400) format may be generated. For example, a single image may be generated for each of the parameters X, Y, and Z corresponding to position information.

For example, a 2D image having a YUV 444 format may be generated. For example, a 2D image having a YUV 444 format may be generated using X, Y, and Z corresponding to position information.

Meanwhile, according to one embodiment of the present disclosure, additional grouping may be performed on structured 2D images. The images may be grouped into N groups based on the characteristics of Gaussian parameters. In this case, the grouped images may be input into a 2D video codec for encoding, group by group. Here, N may be an integer greater than 0.

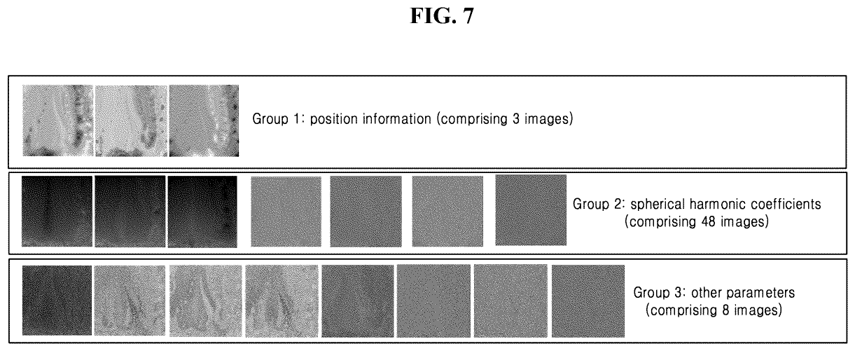

FIG. 7 is a diagram illustrating, as an embodiment according to the present disclosure, an example of grouped two-dimensional images according to one embodiment of the present disclosure.

Referring to FIG. 7, the 2D images may be grouped into three groups. More specifically, the Three images generated for position information may be grouped into Group 1. Forty-eight images generated for spherical harmonic coefficients may be grouped into Group 2. The eight images generated for scale information, rotation information, and opacity information may be grouped into Group 3.

In another example, the 2D images may be grouped into 6 groups. More specifically, three images generated for position information may be grouped into Group 1. Three images generated for DC spherical harmonic coefficients among the spherical harmonic coefficients may be grouped into Group 2. Forty-five images generated for AC spherical harmonic coefficients among the spherical harmonic coefficients may be grouped into Group 3. Three images generated for scale information may be grouped into Group 4. Four images generated for rotation information may be grouped into Group 5. One image generated for opacity information may be grouped into Group 6.

Information about grouping may be predefined in the encoding apparatus and decoding apparatus.

Alternatively, information regarding grouping may be encoded into a bitstream and transmitted from an encoding apparatus to a decoding apparatus. The information may include at least one of the number of groups, the arrangement order of the 2D images within a group, and the Gaussian parameter type corresponding to a 2D image within the group. In this case, the information may be encoded by defining it as an SEI message and transmitted. The information may be encoded and transmitted at at least one of a sequence level, a picture level, a slice level, and a tile level.

For 2D images within a group, intra-prediction or inter-prediction may be performed and encoded.

Meanwhile, Table 1 below illustrates an example of an SEI message according to the present disclosure.

TABLE 1

| | Descriptor |
|---|---|
| gaussian_splatting_information( payloadSize ) { | |
| gsi_cancel_flag | u(1) |
| if( !gsi_cancel_flag ) { | |
| gsi_persistence_flag | u(1) |
| gsi_block_size[0] | u(16) |
| gsi_block_size[1] | u(16) |
| gsi_sh_conversion | u(2) |
| gsi_3dgs_bitdepth_pos | u(8) |
| gsi_3dgs_bitdepth_att | u(8) |
| gsi_transform_position_flag | u(1) |
| gsi_msb_bitdepth_present_flag | u(1) |
| if (gsi_msb_bitdepth_present_flag ) { | |
| gsi_msb_bitdepth | u(5) |
| } | |
| gsi_lsb_bitdepth_present_flag | u(1) |
| if (gsi_msb_bitdepth_present_flag ) { | |
| gsi_lsb_bitdepth | u(5) |
| } | |
| gsi_video_format | u(2) |
| gsi_packing_mode | u(1) |
| gsi_bitdepth | u(4) |
| gsi_quantization | u(1) |
| gsi_number_of_components_minus1 | u(7) |
| for( i = 0; i <= gsi_number_of_components_minus1; | |
| i++ ) { | |
| gsi_components[ i ] | u(7) |
| gsi_min_value[ i ] | u(32) |
| gsi_max_value[ i ] | u(32) |
| } | |
| } | |
| } | |

An SEI message according to the present disclosure may specify information for interpreting 3D Gaussian splatting data included in an associated encoded video. The SEI message of the present disclosure may also be referred to as a Gaussian splatting information (GSI) SEI message.

Referring to Table 1, the SEI provides component identity, packing mode, video format, bit depth, and component-specific dequantization parameters, enabling the decoding apparatus to clearly reconstruct 3DGS properties. Here, the component or component data may represent Gaussian parameters for 3D Gaussian splatting.

According to one embodiment of the present disclosure, when 3DGS data is represented by multiple videos, each video may include a GSI SEI message to define the data stored in that video, as follows.

Referring to Table 1, gsi_cancel_flag may be defined in an SEI message and transmitted. When a value of the gsi_cancel_flag is 1, the SEI may cancel the persistence of a previous SEI message in the output order of the same encoded video. In this case, no additional syntax elements may be present. When a value of the gsi_cancel_flag is 0, it may indicate that 3DGS representation information follows. That is, at least one of the parameters described below may be encoded into the bitstream and transmitted. Here, for two SEI messages, seiA and seiB, included in different access units (AUs), when an image of the AU including auB is located after an image of the AU including auA in output order, it may be said that seiB follows seiA in the output order.

Referring to Table 1, if the value of gsi_cancel_flag is 0, gsi_persistence_flag may be encoded into the bitstream and transmitted. gsi_persistence_flag may specify the persistence of packed regions information SEI messages. If the value of gsi_persistence_flag is 0, the SEI may only be applied to the current access unit (AU). If the value of gsi_persistence_flag is 1, the SEI message may be applied to the current AU and can indicate that it persists to all subsequent AUs in the output order until one of the following conditions is true:
When a new CVS starts.
When the bitstream ends.
When another SEI message exists in a subsequent AU in the output order.

Referring to Table 1, when the value of gsi_cancel_flag is 0, gsi_block_size[0] and/or gsi_block_size[1] may be encoded into the bitstream and transmitted. gsi_block_size[0] and gsi_block_size[1] specify the width and height of a block in sample units, respectively, and may define a logical grid for arranging component data. The above parameter pair may define a raster order (x,y) for indexing components within the block grid. The Gaussian index corresponding to a location (x,y) within the grid may be calculated as follows: idx=y*gsi_block_size[0]+x.

Referring to Table 1, if the value of gsi_cancel_flag is 0, gsi_sh_conversion may be encoded into the bitstream and transmitted. gsi_sh_conversion may indicate a color conversion rule applied to the spherical harmonic (SH) color components prior to packing. For example, if the value of gsi_sh_conversion is 0, it may mean that the color region is empty or unspecified. If the value of gsi_sh_conversion is 1, it may mean that the color region is specified as BT.601. If the value of gsi_sh_conversion is 2, it may mean that the color region is specified as BT.709. If the value of gsi_sh_conversion is 3, it may mean that the color region is specified as BT.2020.

Referring to Table 1, when the value of gsi_cancel_flag is 0, gsi_3dgs_bitdepth_pos and/or gsi_3dgs_bitdepth_att may be encoded into the bitstream and transmitted. gsi_3dgs_bitdepth_pos and gsi_3dgs_bitdepth_att may indicate the internal reconstruction recommended bit depth after performing dequantization on the position component and attribute component among the components, respectively. For example, gsi_3dgs_bitdepth_pos and gsi_3dgs_bitdepth_att may have any one of the values of 12, 18, or 32, respectively.

However, the disclosed values are only examples and may have values different from the disclosed values.

Referring to Table 1, if the value of gsi_cancel_flag is 0, gsi_transform_position_flag may be encoded into the bitstream and transmitted. gsi_transform_position_flag may indicate whether the position component is undergone a sign log transform and whether an inverse transform is required.

Referring to Table 1, when the value of gsi_cancel_flag is 0, gsi_msb_bitdepth_present_flag and/or gsi_lsb_bitdepth_present_flag may be encoded into the bitstream and transmitted. gsi_msb_bitdepth_present_flag and gsi_lsb_bitdepth_present_flag may indicate whether gsi_msb_bitdepth and gsi_lsb_bitdepth are stored in the SEI, respectively. If the values of the above two flags are false, the values of gsi_msb_bitdepth and gsi_lsb_bitdepth may be set to 0. gsi_msb_bitdepth and gsi_lsb_bitdepth may indicate the number of bits used to store MSB and LSB values, respectively. If the values of gsi_msb_bitdepth and gsi_lsb_bitdepth are not set or are 0, the bit depth of the video may be used to reconstruct the geometry signal.

Referring to Table 1, if the value of gsi_cancel_flag is 0, gsi_video_format may be encoded into the bitstream and transmitted. gsi_video_format may specify the chroma format used to store components in the video. If the value of gsi_video_format is 0, it may indicate that the chroma format is specified as 4:0:0. If the value of gsi_video_format is 1, it may indicate that the chroma format is specified as 4:2:0. If the value of gsi_video_format is 2, it may indicate that the chroma format is specified as 4:2:2. If the value of gsi_video_format is 3, it may indicate that the chroma format is specified as 4:4:4. If the chroma format is 4:0:0, all components may be contained in the luma plane. For the chroma format, the packing rules defined as gsi_packing_mode may be followed.

Referring to Table 1, if the value of gsi_cancel_flag is 0, gsi_packing_mode may be defined and transmitted. gsi_packing_mode may specify the component placement method. If the value of gsi_packing_mode is 0, it may indicate that the component placement method is PLANAR. If the value of gsi_packing_mode is 1, it may indicate that the component placement method is TEMPORAL. Specifically, when the component layout is PLANAR(0), the components are mapped to the available planes in the listed order, using the block grid defined by gsi_block_size[0 . . . 1] within each picture. Specifically, when the component layout is TEMPORAL, the components may be assigned to consecutive frames in the listed order (frame t0+i contains component i). When gsi_video_format is not YUV400, chroma planes are filled in both modes, in which case three 3DGS components may be stored in each block.

Referring to Table 1, if the value of gsi_cancel_flag is 0, gsi_bitdepth may be defined and transmitted. gsi_bitdepth may specify the bit depth of the encoded samples in the video.

Referring to Table 1, if the value of gsi_cancel_flag is 0, gsi_quantization may be defined and transmitted. gsi_quantization may specify a quantization model. If the value of gsi_quantization is 0, it may indicate a linear model. If the value of gsi_quantization is 1, it may indicate a Gaussian model.

Referring to Table 1, if the value of gsi_cancel_flag is 0, gsi_number_of_components_minus1 may be defined and transmitted. gsi_number_of_components_minus1 may specify the number of components to be transmitted. The number of components is calculated as Nc=value+1, and the components may be interpreted in the listed order.

Referring to Table 1, gsi_components[i] may be defined in the SEI message and transmitted. gsi_components[i] may identify a 3DGS component stored at position i. gsi_components[i] may be sequentially encoded and transmitted according to the number of components specified by gsi_number_of_components_minus1. The code used to encode the 3DGS component index may be found in Table 2 below.

Table 2 below shows an example of a code used to encode/decode a 3DGS component index according to the present disclosure.

TABLE 2

| code | 3DGS components | Semantics |
|---|---|---|
| 0-2 | x, y, z | MSB part of the geometry |
| | | components |
| 3 | opacity | Opacity component |
| 4-6 | scale_x, scale_y, scale_z | Scale components |
| 7-10 | rot_x, rot_y, rot_z, rot_w | Rotation coordinates |
| 11-13 | f_dc_0, f_dc_1, f_dc_2 | DC components |
| 14 . . . 59 | f_rest_0/f_rest_44 | Spherical harmonic |
| | | components |
| 60-62 | x_add, y_add, z_add | LSB part of the geometry |
| | | coordinates |
| 63 | zero | Empty |

The 3DGS components may be understood as 3D Gaussian parameters. The position components, opacity components, scale components, rotation components, and spherical harmonic color components according to the present disclosure may be understood as position information, opacity information, scale information, rotation information, and spherical harmonic coefficients, respectively.

Referring to Table 2, codes 0 through 2 correspond to the coordinates (x, y, z) of the 3DGS components, which may represent the MSB of the position (geometric) component.

Referring to Table 2, code 3 corresponds to the opacity component of the 3DGS components, which may represent the opacity component.

Referring to Table 2, codes 4 through 6 correspond to the scale (x, y, z) component of the 3DGS components, which may represent the scale component.

Referring to Table 2, codes 7 through 10 correspond to the rotation (x, y, z, w) component of the 3DGS components, which may represent the rotation component.

Referring to Table 2, codes 11 through 13 correspond to DC coefficients among 3DGS components, which may represent spherical harmonic color components.

Referring to Table 2, codes 14 through 59 correspond to AC coefficients among 3DGS components, which may represent spherical harmonic color components.

Referring to Table 2, codes 60 through 62 correspond to correction coordinates (x_add, y_add, z_add) among 3DGS components, which may represent the LSB of the position (geometric) component.

However, the disclosed embodiments are merely examples and may have different values.

Meanwhile, gsi_min_value[i] and/or gsi_max_value[i] may be defined in the SEI message and transmitted. gsi_min_value[i] and gsi_max_value[i] may define the minimum and maximum values of the components used when performing dequantization, respectively.

Table 3 below shows an example of an SEI message according to the present disclosure.

TABLE 3

| | Descriptor |
|---|---|
| gaussian_splatting_information( payloadSize ) { | |
| gsi_cancel_flag | u(1) |
| if( !gsi_cancel_flag ) { | |
| gsi_persistence_flag | u(1) |
| gsi_attribute_region_width_minus1 | ue(v) |
| gsi_attribute_region_height_minus1 | ue(v) |
| gsi_num_gaussians_minus1 | ue(v) |
| gsi_num_layers_minus1 | ue(v) |
| for( i= 0; i <= gsi_num_layers_minus1; i++ ) | |
| gsi_layer_id[ i ] | ue(v) |
| gsi_colour_description_present_flag | u(1) |
| if( gsi_colour_description_present_flag ) { | |
| gsi_colour_primaries | u(8) |
| gsi_transfer_characteristics | u(8) |
| gsi_matrix_coeffs | u(8) |
| gsi_full_range_flag | u(1) |
| } | |
| gsi_normalization_idc | u(2) |
| gsi_rotation_idc | u(2) |
| gsi_num_attributes_minus1 | ue(v) |
| for( i = 0; i < gsi_num_ attributes_minus1; i++ ) { | |
| gsi_attributes_id[ i ] | ue(v) |
| for( j = 0; j < NumAttrComp[ AttrId ]; j++) { | |
| gsi_attribute_normalization_param0 [ i ][ j ] | se(v) |
| gsi_attribute_normalization_param1[ i ][ j ] | ue(v) |
| gsi_attribute_bitdepth_present_flag[ i ][ j ] | u(1) |
| if( gsi_attribute_bitdepth_present_flag[ i ][ j ] ) | |
| gsi_attribute_bitdepth[ i ][ j ] | ue(v) |
| gsi_transform_enable_flag[ i ][ j ] | u(1) |
| if( gsi_transform_enable_flag[ i ][ j ] ) | |
| gsi_transform_idc[ i ][ j ] | ue(v) |
| } | |
| } | |
| gsi_frame_packing_idc | ue(v) |
| if( frame_packing_idc !== 0 ) { | |
| for( l = 0; l <= gsi_num_layers_minus1; l++ ) { | |
| gsi_num_constituent_frames_minus1[ l ] | ue(v) |
| for( i = 0; i <= gsi_num_constituent_frames_minus1[ l ]; i++ ) { | |
| gsi_num_packed_attributes_minus1[ l ][ i ] | ue(v) |
| for( j = 0; j <= gsi_num_packed_attributes_minus1[ l ][ i ]; i++ ) { | |
| gsi_packed_attribute_id[ l ][ i ][ j ] | ue(v) |
| for( k=0; k< NumAttrComp[PackAttrId] ; k++ ) { | |
| gsi_color_plane_idc[ l ][ i ][ j ][ k ] | ue(v) |
| gsi_region_top_left_x[ l ][ i ][ j ][ k ] | ue(v) |
| gsi_region_top_left_y[ l ][ i ][ j ][ k ] | ue(v) |
| } | |
| } | |
| } | |
| } | |
| } | |
| } | |
| } | |

The OSI SEI message may provide 3DGS representation information that may be used for 3D rendering.

According to one embodiment of the present disclosure, the following variables may need to be defined to use the SEI message.
PicWidthInLumaSamples and PicHeightInLumaSamples: Picture width and height in luma samples
CtbSizeY: Luma coding tree block size
ChromaFormatIdc: Chroma format indicator (described in Section 7.3 of the VSEI specification)
DecodedPicture[cIdx][y][x]: Array of cropped decoded pictures
cIdx=0 . . . (ChromaFormatIdc==0)?0:2, y=0 . . . PicHeightInLumaSamples−1, x=0 . . . PicWidthInLumaSamples[gsi_layer_id−1]
BitDepthY: Bit depth of the luma component
BitDepthC: Bit depth of the chroma component (when ChromaFormatIdc≠0).

According to one embodiment of the present disclosure, when 3DGS data is represented by multiple videos, each video may include a GSI SEI message to define the data stored in that video, as follows.

Referring to Table 3, the gsi_cancel_flag may be defined in the SEI message and transmitted. If gsi_cancel_flag is 1, it may indicate that the SEI cancels the persistence of all previous packed regions information SEI messages in the output order. On the other hand, if gsi_cancel_flag is 0, it may indicate that 3DGS representation information follows. That is, at least one of the parameters described below may be encoded into the bitstream and transmitted.

Referring to Table 3, when the value of gsi_cancel_flag is 0, gsi_persistence_flag may be encoded into the bitstream and transmitted. gsi_persistence_flag may specify the persistence of the packed regions information SEI message. When the value of gsi_persistence_flag is 0, the SEI may only be applied to the current access unit (AU). When the value of gsi_persistence_flag is 1, it may indicate that the SEI message applies to the current AU and persists to all subsequent AUs in the output order until one of the following conditions is true:
When a new CVS starts.
When the bitstream ends.
When another SEI message exists in a subsequent AU in the output order.

Referring to Table 3, when the value of gsi_cancel_flag is 0, gsi_attribute_region_width_minus1 and/or gsi_attribute_region_height_minus1 may be encoded into the bitstream and transmitted. The values of gsi_attribute_region_width_minus1 and gsi_attribute_region_height_minus1 plus 1 may specify the width and height of the region related to the Gaussian attribute component in CtbSizeY units, respectively. Here, the values of gsi_attribute_region_width_minus1 and gsi_attribute_region_height_minus1 may be restricted to the range of 0 to 65535.

In this case, the variable gsiWidth may be set to gsi_attribute_region_width_minus1+1, and the variable gsiHeigh may be set to gsi_attribute_region_height_minus1+1.

Referring to Table 3, when the value of gsi_cancel_flag is 0, gsi_num_gaussians_minus1 may be encoded into the bitstream and transmitted. The value of gsi_num_gaussians_minus1 plus 1 may specify the number of Gaussians. Here, the value of gsi_num_gaussians_minus1 may be restricted to a range from 0 to 2³²−2. Here, the value of gsi_num_gaussians_minus1 may be restricted to less than or equal to gsiWidth*gsiHeight. When gsi_num_gaussians_minus1 is less than gsiWidth*gsiHeight, the first gsi_num_gaussians_minus1+1 samples in the region are connected to a Gaussian splat in raster scan order, and the remaining samples can be set to 0.

Referring to Table 3, if the value of gsi_cancel_flag is 0, gsi_num_layers_minus1 may be encoded into the bitstream and transmitted. The value of gsi_num_layers_minus1 plus 1 may specify the number of layers related to the Gaussian splatting attributes. The value of gsi_num_layers_minus1 may be restricted to the range of 0 to 1023.

Referring to Table 3, gsi_layer_id[i] may be defined in the SEI message and transmitted. gsi_layer_id[i] may specify the ith layer ID in which the Gaussian splatting attributes are encoded. gsi_layer_id[i] may be sequentially encoded and transmitted according to the number of layers related to the Gaussian splatting attributes specified in gsi_number_of_components_minus1. The value of gsi_layer_id[i] may be restricted to the range of 0 to 2047. If i and j are different, gsi_layer_id[i] and gsi_layer_id[j] shall not be equal. In this case, the range of the value of gsi_layer_id[i] may be further restricted in the interface statement of a specific video encoding standard specification.

Referring to Table 3, if the value of gsi_cancel_flag is 0, gsi_colour_description_present_flag may be encoded into the bitstream and transmitted. If the value of gsi_colour_description_present_flag is 1, it may indicate that color description information related to spherical harmonic expression exists in the current SEI message. If the value of gsi_colour_description_present_flag is 0, it may indicate that the color description information related to spherical harmonic expression is the same as the information of the VUI.

Referring to Table 3, if the value of gsi_colour_description_present_flag is 1, gsi_colour primaries may be encoded into the bitstream and transmitted. gsi_colour primaries has the same meaning as that specified in the vui_colour primaries syntax element in Section 7.3 of the VSEI specification and may be applied to spherical harmonic representation.

Referring to Table 3, if the value of gsi_colour_description_present_flag is 1, gsi_transfer_characteristics may be encoded into the bitstream and transmitted. gsi_transfer_characteristics has the same meaning as the vui_transfer_characteristics element and may be applied to spherical harmonic expression.

Referring to Table 3, if the value of gsi_colour_description_present_flag is 1, gsi_matrix_coeffs may be encoded into the bitstream and transmitted. gsi_matrix_coeffs has the same meaning as the vui_matrix_coeffs element and may be applied to spherical harmonic expression.

Referring to Table 3, if the value of gsi_colour_description_present_flag is 1, gsi_full_range_flag may be encoded into the bitstream and transmitted. gsi_full_range_flag has the same meaning as the vui_full_range_flag element and may be applied to spherical harmonic expression.

Referring to Table 3, if the value of gsi_cancel_flag is 0, gsi_normalization_idc may be encoded into the bitstream and transmitted. A value of gsi_normalization_idc of 0 may indicate that the normalization method uses the offset and scale of the Gaussian splat. The value of gsi_normalization_idc of 1 may indicate that the normalization method uses the minimum and maximum values of the Gaussian splat. The values 2 and 3 of gsi_normalization_idc are reserved for future use in ITU-T|ISO/IEC and should not be present in a bitstream conforming to this version of the document. A decoding apparatus conforming to this version of the document should ignore SEI messages with a gsi_normalization_idc value between 2 and 3.

Referring to Table 3, when the value of gsi_cancel_flag is 0, gsi_rotation_idc may be encoded into the bitstream and transmitted. A value of gsi_rotation_idc of 0 may indicate that the rotation of the Gaussian splat is a quaternion rotation. The value of gsi_rotation_idc of 1 may indicate that the rotation of the Gaussian splat is an Euler angle rotation. The values 2 and 3 of gsi_rotation_idc are reserved for future use in ITU-T|ISO/IEC and should not be present in a bitstream conforming to this version of the document. A decoding apparatus conforming to this version of the document should ignore SEI messages with gsi_rotation_idc values between 2 and 3.

Referring to Table 3, if the value of gsi_cancel_flag is 0, gsi_num_attributes_minus1 may be encoded into the bitstream and transmitted. The value obtained by adding 1 to gsi_num_attributes_minus1 may specify the number of attributes associated with the SEI message.

Referring to Table 3, gsi_attributes_id[i] may be defined in the SEI message and transmitted. gsi_attributes_id[i] may be sequentially encoded and transmitted according to the number of attributes associated with the SEI message specified in gsi_num_attributes_minus1.

Meanwhile, Table 4 illustrates an example of the identifier (ID) and number of basic components of Gaussian splatting attributes according to the present disclosure.

TABLE 4

| | means | means | | | | SH |
|---|---|---|---|---|---|---|
| Attribute | MSB | LSB | Scale | Rotation | Opacity | {0 . . . 15} |
| AttrId | 0 | 1 | 2 | 3 | 4 | 5 . . . 20 |
| NumAttrComp[AttrId] | 3 | 3 | 3 | 3 | 1 | 3 |
| Total regions | 3 | 3 | 3 | 3 | 1 | 48 |

The above-described gsi_attributes_id[i] may represent the identifier of the ith attribute specified in Table 4. The variable AttrId may be set to the same value as gsi_attributes_id[i].

Referring to Table 4, AttrId 0 may correspond to the most significant bit (MSB) of the geometric coordinate. The number of components of the most significant bit of the geometric coordinate (NumAttrComp [AttrId]) may be three.

Referring to Table 4, AttrId 1 may correspond to the least significant bit (LSB) of the geometric coordinate. The number of components in the least significant bit of the geometric coordinate may be three.

Referring to Table 4, AttrId 2 may correspond to scale information. The number of components in the scale information may be three.

Referring to Table 4, AttrId 3 may correspond to rotation information. The number of components in the rotation information may be four.

Referring to Table 4, AttrId 4 may correspond to opacity information. The number of components in the opacity information may be one.

Referring to Table 4, AttrIds 5 to 20 may correspond to spherical harmonic coefficients. The total number of spherical harmonic color components may be forty-eight.

However, the disclosed embodiment is merely an example, and the identifiers and the number of basic components of the Gaussian splatting attributes may be defined differently.

Meanwhile, referring to Table 3, gsi_attribute_normalization_param0[i][j] may be defined in the SEI message and transmitted. gsi_attribute_normalization_param0[i][j] may be sequentially encoded and transmitted according to the number of components specified in NumAttrComp [AttrId]. gsi_attribute_normalization_param0[i][j] may specify an offset value coefficient for the j-th component of the i-th attribute when the value of gsi_normalization_idc is 0. When the value of gsi_normalization_idc is 1, the minimum value for the j-th component of the i-th attribute may be specified.

Referring to Table 3, gsi_attribute_normalization_param1[i][j] may be defined in the SEI message and transmitted. gsi_attribute_normalization_param1[i][j] may be sequentially encoded and transmitted according to the number of components specified in NumAttrComp [AttrId]. gsi_attribute_normalization_param1[i][j] may specify an offset value coefficient for the j-th component of the i-th attribute when the value of gsi_normalization_idc is 0. When the value of gsi_normalization_idc is 1, the maximum value for the j-th component of the i-th attribute may be specified.

Referring to Table 3, gsi_attribute_bitdepth_present_flag[i][j] may be defined in the SEI message and transmitted. gsi_attribute_bitdepth_present_flag[i][j] may be sequentially encoded and transmitted according to the number of components specified in NumAttrComp [AttrId]. If the value of gsi_attribute_bitdepth_present_flag[i][j] is 1, it indicates that gsi_attribute_bitdepth[i][j] exists, and if it is 0, it indicates that it does not exist.

Referring to Table 3, if the value of gsi_attribute_bitdepth_present_flag[i][j] is 1, gsi_attribute_bitdepth[i][j] may be encoded into in the bitstream and transmitted. gsi_attribute_bitdepth[i][j] may indicate the bit depth of the jth component of the ith attribute. If the bit depth of the jth component of the ith attribute does not exist, gsi_attribute_bitdepth[i][j] is considered to be the same value as BitDepthY.

Referring to Table 3, gsi_transform_enable_flag[i][j] may be defined in the SEI message and transmitted. If the value of gsi_transform_enable_flag[i][j] is 1, it indicates that gsi_transform_idc[i][j] exists, and if it is 0, it indicates that it does not exist. gsi_transform_idc[i][j] may indicate the transform type of the jth component of the ith attribute. The transform types will be examined in detail through Table 5 below.

Table 5 is an example showing the component transform types of GSI according to the present disclosure.

TABLE 5

| idc | Transform type | Transform | Description |
|---|---|---|---|
| 0 | sigmoid | $\frac{1}{1 + {e}^{x}}$ | It may be shown that the values of the ith attribute are mapped to the range [0, 1) |
| | | | using the sigmoid function. For example, |
| | | | it can be applied to opacity. |
| 1 | exponential | e^{x} | It may be used to indicate that an |
| | | | exponential function should be applied to |
| | | | remap the value of the ith attribute. For |
| | | | example, [symbol] log [symbol] ₑ x may be applied to |
| | | | reduce the dynamic range of the scale |
| | | | attribute. |
| 2 | generic | b × a^{x} | It may be shown that the value of the ith |
| | exponential | | attribute should be remapped by applying |
| | | | an exponential function with basis “a” and |
| | | | scaling “b”. |

The value of gsi_transform_idc[i][j] may be restricted between 0 and 15.

A value of 0 for gsi_transform_idc[i][j] indicates that a transform using the sigmoid function is applied. A value of 1 for gsi_transform_idc[i][j] indicates that a transform using the exponential function is applied. A value of 2 for gsi_transform_idc[i][j] indicates that a transform using the generic exponential function is applied.

The values 3 through 15 are reserved for future use by ITU-T|ISO/IEC and should not be present in bitstreams conforming to this version of the document. A decoding apparatus conforming to this version of the document should ignore SEI messages with gsi_transform_idc values between 3 and 15.

Meanwhile, referring to Table 3, if the value of gsi_cancel_flag is 0, gsi_frame_packing_idc may be encoded into the bitstream and transmitted. gsi_frame_packing_idc may specify how to interpret the sample array of the output cropped decoded image. If the value of gsi_frame_packing_idc is 0, packing may be explicitly specified.

Referring to Table 3, if the value of gsi_frame_packing_idc is not 0, gsi_num_constituent_frames_minus1[l] may be encoded into the bitstream and transmitted. gsi_num_constituent_frames_minus1[l] may be sequentially encoded and transmitted according to the number of layers related to the attribute specified in gsi_num_layers_minus1. gsi_num_constituent_frames_minus1[l]+1 may specify the number of constituent frames of the lth layer related to the SEI message. Here, the constituent frame may mean a part of a spatially frame-packed picture related to 3DGS.

Referring to Table 3, if the value of gsi_frame_packing_idc is not 0, gsi_num_packed_attributes_minus1[l][i] may be defined and transmitted. gsi_num_packed_attributes_minus1[l][i] may be sequentially encoded and transmitted according to the number of constituent frames of the layer specified in gsi_num_constituent_frames_minus1[l]. gsi_num_packed_attributes_minus1[l][i]+1 may specify the number of attributes packed in the i-th constituent frame of the l-th layer.

Referring to Table 3, if the value of gsi_frame_packing_idc is not 0, gsi_packed_attribute_id[l][i][j] may be encoded into the bitstream and transmitted. gsi_packed_attribute_id[l][i][j] may be sequentially encoded and transmitted according to the number of attributes packed in the configuration frame specified in gsi_num_packed_attributes_minus1[l][i]. gsi_packed_attribute_id[l][i][j] may indicate the identifier of the jth attribute packed in the ith configuration frame of the lth layer. In this case, the variable PackAttrId may be set equal to gsi_packed_attribute_id[l][i][j].

Referring to Table 3, if the value of gsi_frame_packing_idc is not 0, gsi_color_plane_idc[l][i][j][k] may be encoded into the bitstream and transmitted. gsi_color_plane_idc[l][i][j][k] may be sequentially encoded and transmitted according to the number of attributes packed in the configuration frame specified in NumAttrComp[PackAttrId]. If the value of gsi_color_plane_idc[l][i][j][k] is 0, it indicates that the corresponding color component is luma Y, if it is 1, it indicates chroma Cb, and if it is 2, it indicates chroma Cr. The value of gsi_color_plane_idc[l][i][j][k] may be restricted to a range from 0 to 7. In this case, values between 3 and 7 are reserved for future use by ITU-T|ISO/IEC and should not be present in bitstreams conforming to this version of the document. A decoding apparatus conforming to this version of the document should ignore SEI messages with gsi_color_plane_idc values between 3 and 7.

Referring to Table 3, if the value of gsi_frame_packing_idc is not 0, gsi_region_top_left_x[l][i][j][k] and/or gsi_region_top_left_y[l][i][j][k] may be encoded into the bitstream and transmitted. gsi_region_top_left_x[l][i][j][k] and/or gsi_region_top_left_y[l][i][j][k] may be sequentially encoded and transmitted according to the number of attributes packed in the configuration frame specified in NumAttrComp[PackAttrId]. gsi_region_top_left_x[l][i][j][k] may specify the horizontal position of the region related to the kth component of the jth attribute in the ith cropped decoded image of the lth layer, in sample units, respectively. gsi_region_top_left_y[l][i][j][k] may specify the vertical position of the region related to the kth component of the jth attribute in the ith cropped decoded image of the lth layer, in sample units, respectively.

Assuming that the jth component of the ith attribute of the Gaussian is related to the sample x, the jth component value of the ith attribute of the Gaussian, gValue[i][j], may be calculated as follows:

$$gValue [ i ] [ j ] = gsi\_attribute \_normalization \_param1 [ i ] [ j ] * ( x - gsi\_attribute \_normalization \_param0 [ i ] [ j ] )$$

However, when gsi_normalization_idc=0 and gsi_rotation_idc=0, the four quaternion components may be calculated from the three attributes as follows.

$$q [ k ] = gValue [ 3 ] [ k ]$$

$$q [ 3 ] = s q r t ( 1 - ( q [ 0 ] 2 + q [ 1 ] 2 + q [ 2 ] 2 ) )$$

Here, q[0]2+q[1]2+q[2]2≤1.

Meanwhile, since quaternions (q0, q1, q2, q3) and (−q0, −q1, −q2, −q3) represent the same 3D rotation, the encoding apparatus may signalize all components by inverting their signs so that q3 does not become negative.

When gsi_rotation_idc=1, the three Euler angles may be computed as follows:

$$Euler\_angle \_roll = value [ 3 ] [ 0 ]$$

$$Euler\_angle \_pitch = value [ 3 ] [ 1 ]$$

$$Euler\_angle \_yaw = value [ 3 ] [ 2 ]$$

Any sample (x, y) in the image should belong to at most one attribute region, and all attribute regions should be completely contained within the image.

Meanwhile, in the method proposed in this disclosure, the Gaussian parameters for the 3D Gaussian representing the scene are not limited to position information, rotation information, scale information, opacity information, and spherical harmonic coefficients. The method of this disclosure may also be applied to models that include additional Gaussian parameters, and structuring may be performed for the additional Gaussian parameters to generate and encode a 2D image.

For example, the method of the present disclosure may also be applied to a dynamic four-dimensional (4D) Gaussian model. The dynamic Gaussian model may include time as an additional parameter. Structuring may also be performed on the Gaussian parameters included in the dynamic 4D Gaussian model to generate and encode a 2D image.

For example, the method of the present disclosure may also be applied to a 4D Gaussian model including Gaussian embedding information for each Gaussian to represent a dynamic scene.

Here, embedding may mean representing data in a vector space by mapping it to a vector space.

The Gaussian embedding information for each Gaussian may be expressed in N dimensions. The N-dimensional embedding information may be expressed as an N-bit floating-point number. Here, N may be an integer greater than 0. For example, N may be 32.

The Gaussian embedding information for each Gaussian included in the 4D Gaussian model may also be structured to generate and encode a 2D image.

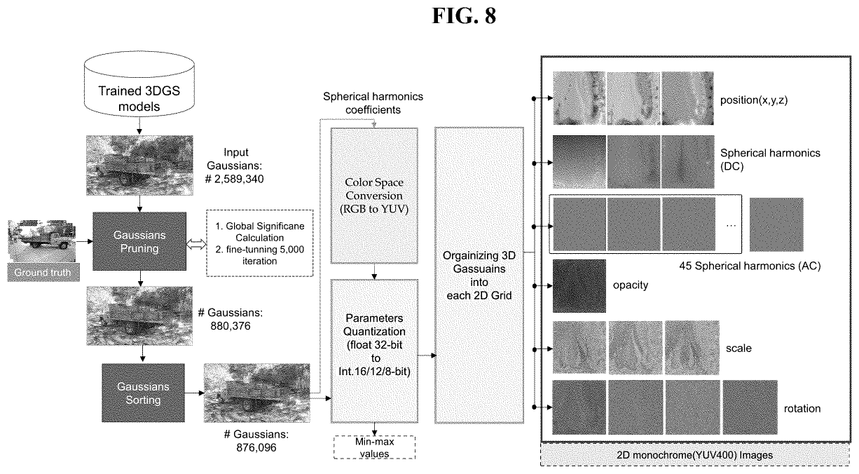

FIG. 8 is a diagram illustrating, according to the present disclosure, an embodiment of encoding Gaussian parameters based on two-dimensional image structuring.

Referring to FIG. 8, 2,589,340 Gaussians may be initially input.

Referring to FIG. 8, Gaussian pruning may be performed on the input initial Gaussians. The Gaussian pruning may be performed based on importance information calculations.

Referring to FIG. 8, fine-tuning may be performed on the pruned Gaussians.

Fine-tuning may be performed through N iterations, where N may be an integer greater than or equal to 0. For example, N may be 5000.

Referring to FIG. 8, 880,376 Gaussians may be derived as a result of pruning and fine-tuning.

Referring to FIG. 8, sorting may be performed on the Gaussian parameters of the pruned Gaussians. If truncation is performed on some Gaussian parameters during the sorting process, the number of Gaussians may be reduced. For example, referring to FIG. 8, 876,096 Gaussians may be derived as a result of sorting.

Referring to FIG. 8, the color space of at least one spherical harmonic coefficient included in the sorted Gaussian parameters may be converted. The spherical harmonic coefficient may be converted from an RGB color space to a YUV color space.

Referring to FIG. 8, Gaussian parameters may be quantized. Among the Gaussian parameters, spherical harmonic coefficients may be quantized after conversion. Quantization may be performed by calculating the minimum and maximum values for each Gaussian parameter.

Referring to FIG. 8, structuring is performed on quantized Gaussian parameters to generate a 2D image, which may then be encoded.

Referring to FIG. 8, the 2D images may be grouped into six groups. More specifically, three images generated based on position information may be grouped into Group 1. Among the spherical harmonic coefficients, three images generated for the DC spherical harmonic coefficients may be grouped into group 2. Forty-five images generated for the AC spherical harmonic coefficients may be grouped into group 3. three images generated for scale information may be grouped into group 4. Four images generated for rotation information may be grouped into group 5. One image generated for opacity information may be grouped into group 6.

Referring to FIG. 8, the generated 2D image may have a single format.

The pruning, sorting, color space conversion, quantization, and structuring processes have been discussed in detail with reference to FIG. 2, so a detailed description will be omitted.

The embodiment described with reference to FIG. 8 is merely an example, and different results may be derived.

Meanwhile, the present disclosure aims to provide a encoding/decoding stream structure for transmitting and receiving Gaussian parameters.

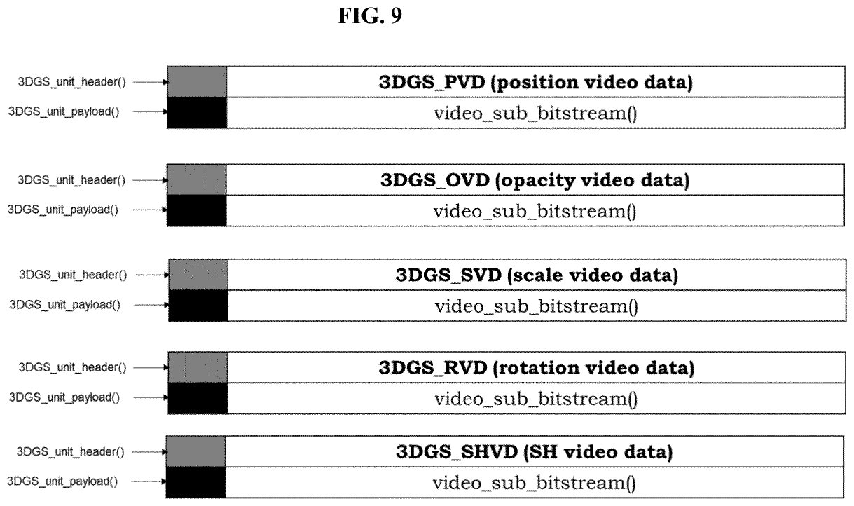

FIG. 9 is a diagram illustrating, as an embodiment according to the present disclosure, a 3DGS encoding stream structure.

Referring to FIG. 9, a bitstream for transmitting Gaussian parameters may include 3D Gaussian splatting unit sets.

A 3DGS unit set may include one or more 3DGS units. A 3DGS unit may include a 3DGS unit header and/or a 3DGS unit payload.

Table 6 below illustrates the structure of a 3DGS unit syntax.

TABLE 6

Descriptor

```
3DGS_unit(numBytesIn3DGSUnit) {
  3DGS_unit_header( )
  3DGS_unit_payload(numBytesIn3DGSUnit −4)
}
```

Referring to Table 6, a 3DGS unit may include a 3DGS unit header and/or a 3DGS unit payload. Table 7 below illustrates examples of 3DGS unit types.

The following Table 7 shows an example of 3DGS unit type.

TABLE 7

| vuh_{—} | | | |
|---|---|---|---|
| unit_{—} | | | |
| type | Identifier | 3DGS unit type | Description |
| 0 | V3C_VPS | 3DGS parameter set | 3DGS level parameters |
| 1 | 3DGS_PVD | Position video data | Position information |
| 2 | 3DGS_OVD | Opacity video data | Opacity information |
| 3 | 3DGS_SVD | Scale video data | Scale information |
| 4 | 3DGS_RVD | Rotation video data | Rotation information |
| 5 | 3DGS_SHVD | Spherical harmonic | Spherical harmonic |
| | | video data | information |
| 6 . . . | _RSVD | Reserved | — |
| 31 | | | |

Table 7 shows the correspondence between vuh_unit_type, identifier, and 3DGS unit type.

A 3DGS unit type may include at least one of a 3DGS parameter set, Position Video Data (PVD), Opacity Video Data (OPD), Scale Video Data (SVD), Rotation Video Data (RVD), and Spherical Harmonic Video Data (SHVD).

Referring to Table 7, when vuh_unit_type is 0, the identifier may be set to V3C_VPS, and the 3DGS unit type may be defined as a 3DGS parameter set. This may mean a 3DGS level parameter.

Referring to Table 7, when vuh_unit_type is 1, the identifier may be set to 3DGS_PVD, and the 3DGS unit type may be defined as position video data (PVD). PVD may indicate position information in the three-dimensional space of 3D Gaussian splatting.

Referring to Table 7, when vuh_unit_type is 2, the identifier may be set to 3DGS_OVD, and the 3DGS unit type may be defined as opacity video data (OVD). OVD may indicate opacity information of 3D Gaussian splatting.

Referring to Table 7, when vuh_unit_type is 3, the identifier may be set to 3DGS_SVD, and the 3DGS unit type may be defined as scaled video data (SVD). SVD may indicate scale information of 3D Gaussian splatting.

Referring to Table 7, when vuh_unit_type is 4, the identifier may be set to 3DGS_RVD, and the 3DGS unit type may be defined as rotation video data (RVD). RVD may indicate rotation information of 3D Gaussian splatting.

Referring to Table 7, when vuh_unit_type is 5, the identifier may be set to 3DGS_SHVD, and the 3DGS unit type may be defined as spherical harmonic video data (SHVD). SHVD may indicate spherical harmonic coefficients for expressing color values. For example, the spherical harmonic coefficients may be information for expressing color values according to 48 viewpoints, and can include 3 DC spherical harmonic coefficients and 45 AC spherical harmonic coefficients.

However, the above disclosed embodiment is merely an example, and the 3DGS unit type may be defined differently.

Table 8 below shows an example of a 3DGS unit header.

TABLE 8

| | Descriptor |
|---|---|
| 3DGS_unit_header( ) { | |
| vuh_unit_type | u(n) |
| if ( vuh_unit_type == 3DGS_PVD ∥ vuh_unit_type == 3DGS_OVD ∥ | |
| vuh_unit_type == 3DGS_SVD ∥ vuh_unit_type == 3DGS_RVD ∥ vuh_unit_type | |
| == 3DGS_SHVD) { | |
| } | |
| if (vuh_unit_type == 3DGS_PVD) { | |
| vuh_pos_attribute_index | u(n) |
| } | |
| if (vuh_unit_type == 3DGS_SVD) { | |
| vuh_scale_attribute_index | u(n) |
| } | |
| if (vuh_unit_type == 3DGS_RVD) { | |
| vuh_rotation_attribute_index | u(n) |
| } | |
| if (vuh_unit_type == 3DGS_SHVD) { | |
| vuh_rsh_attribute_index | u(n) |
| } | |

Referring to Table 8, when a 3DGS_unit_header is encoded and transmitted, a vuh_unit_type may also be encoded and transmitted. The vuh_unit_type may be defined as described in Table 7 above. Since it has already been explained with reference to Table 7, a detailed description thereof will be omitted here.

Referring to Table 8, when vuh_unit_type is 3DGS_PVD, vuh_pos_attribute_index may be encoded and transmitted.

Referring to Table 8, when vuh_unit_type is 3DGS_SVD, vuh_scale_attribute_index may be encoded and transmitted.

Referring to Table 8, when vuh_unit_type is 3DGS_RVD, vuh_rotation_attribute_index may be encoded and transmitted.

Referring to Table 8, when vuh_unit_type is 3DGS_SHVD, vuh_rsh_attribute_index may be encoded and transmitted.

However, the disclosed embodiment is merely an example, and the 3DGS unit header may be defined differently.

Tables 9 through 12 below provide examples of indexes for attribute information.

Table 9 provides examples of indexes (vuh_pos_attribute_index) for position attribute information included in position video data (PVD).

TABLE 9

| pos_attribute_index | Identifier | Attribute type |
|---|---|---|
| 0 | Position_X | position X component |
| 1 | Position_Y | position Y component |
| 2 | Position_Z | position Z component |

Referring to Table 9, when pos_attribute_index is 0, the identifier may be set to Position_X, indicating the X component of the position.

Referring to Table 9, when pos_attribute_index is 1, the identifier may be set to Position_Y, indicating the Y component of the position.

Referring to Table 9, when pos_attribute_index is 2, the identifier may be set to Position_Z, indicating the Z component of the position.

However, the disclosed embodiment is merely an example, and the index of the location attribute information may be defined differently.

Table 10 provides an example of an index (vuh_scale_attribute_index) of scale attribute information included in scaled video data (SVD).

TABLE 10

| scale_attribute_index | Identifier | Attribute type |
|---|---|---|
| 0 | Scale_X | Scale X components |
| 1 | Scale_Y | Scale Y components |
| 2 | Scale_Z | Scale Z components |

Referring to Table 10, when scale_attribute_index is 0, the identifier may be set to Scale_X, which may represent the X component of the scale.

Referring to Table 10, when scale_attribute_index is 1, the identifier may be set to Scale_Y, which may represent the Y component of the scale.

Referring to Table 10, when scale_attribute_index is 2, the identifier may be set to Scale_Z, which may represent the Z component of the scale.

However, the disclosed embodiment is merely an example, and the index of the scale attribute information may be defined differently.

Table 11 shows an example of an index (vuh_rotation_attribute_index) of rotation attribute information included in rotation video data (RVD).

TABLE 11

| rotation_attribute_index | Identifier | Attribute type |
|---|---|---|
| 0 | Rotation_X | Rotation X components |
| 1 | Rotation_Y | Rotation Y components |
| 2 | Rotation_Z | Rotation Z components |
| 3 | Rotation_W | Rotation W components |

Referring to Table 11, when rotation_attribute_index is 0, the identifier may be set to Rotation_X, indicating the X component of the rotation.

Referring to Table 11, when rotation_attribute_index is 1, the identifier may be set to Rotation_Y, indicating the Y component of the rotation.

Referring to Table 11, when rotation_attribute_index is 2, the identifier may be set to Rotation_Z, indicating the Z component of the rotation.

Referring to Table 11, when rotation_attribute_index is 3, the identifier may be set to Rotation_W, indicating the W component of the rotation.

However, the disclosed embodiment is merely an example, and the index of the rotation attribute information may be defined differently.

Table 12 shows an example of an index (vuh_rsh_attribute_index) of spherical harmonic attribute information included in spherical harmonic video data (SHVD).

TABLE 12

| rsh_attribute_index | Identifier | Attribute type |
|---|---|---|
| 0 | SH0_R | Spherical harmonic level-0 |
| | | component (R) |
| 1 | SH0_G | Spherical harmonic level-0 |
| | | component (G) |
| 2 | SH0_B | Spherical harmonic level-0 |
| | | component (B) |
| 3 | SH1_R | Spherical harmonic level-1 |
| | | component (R) |
| 4 | SH1_R | Spherical harmonic level-1 |
| | | component (R) |
| 5 | SH1_R | Spherical harmonic level-1 |
| | | component (R) |
| 6 | SH2_R | Spherical harmonic level-2 |
| | | component (R) |
| 7 | SH2_R | Spherical harmonic level-2 |
| | | component (R) |
| 8 | SH2_R | Spherical harmonic level-2 |
| | | component (R) |
| 9 | SH2_R | Spherical harmonic level-2 |
| | | component (R) |
| 10 | SH2_R | Spherical harmonic level-2 |
| | | component (R) |
| 11 | SH3_R | Spherical harmonic level-3 |
| | | component (R) |
| 12 | SH3_R | Spherical harmonic level-3 |
| | | component (R) |
| 13 | SH3_R | Spherical harmonic level-3 |
| | | component (R) |
| 14 | SH3_R | Spherical harmonic level-3 |
| | | component (R) |
| 15 | SH3_R | Spherical harmonic level-3 |
| | | component (R) |
| 16 | SH3_R | Spherical harmonic level-3 |
| | | component (R) |
| 17 | SH3_R | Spherical harmonic level-3 |
| | | component (R) |
| 18 | SH3_G | Spherical harmonic level-1 |
| | | component (G) |
| 19 | SH3_G | Spherical harmonic level-1 |
| | | component (G) |
| 20 | SH3_G | Spherical harmonic level-1 |
| | | component (G) |
| 21 | SH3_G | Spherical harmonic level-2 |
| | | component (G) |
| 22 | SH3_G | Spherical harmonic level-2 |
| | | component (G) |
| 23 | SH3_G | Spherical harmonic level-2 |
| | | component (G) |
| 24 | SH3_G | Spherical harmonic level-2 |
| | | component (G) |
| 25 | SH3_G | Spherical harmonic level-2 |
| | | component (G) |
| 26 | SH3_G | Spherical harmonic level-3 |
| | | component (G) |
| 27 | SH3_G | Spherical harmonic level-3 |
| | | component (G) |
| 28 | SH3_G | Spherical harmonic level-3 |
| | | component (G) |
| 29 | SH3_G | Spherical harmonic level-3 |
| | | component (G) |
| 30 | SH3_G | Spherical harmonic level-3 |
| | | component (G) |
| 31 | SH3_G | Spherical harmonic level-3 |
| | | component (G) |
| 32 | SH3_G | Spherical harmonic level-3 |
| | | component (G) |
| 33 | SH3_B | Spherical harmonic level-1 |
| | | component (B) |
| 34 | SH3_B | Spherical harmonic level-1 |
| | | component (B) |
| 35 | SH3_B | Spherical harmonic level-1 |
| | | component (B) |
| 36 | SH3_B | Spherical harmonic level-2 |
| | | component (B) |
| 37 | SH3_B | Spherical harmonic level-2 |
| | | component (B) |
| 38 | SH3_B | Spherical harmonic level-2 |
| | | component (B) |
| 39 | SH3_B | Spherical harmonic level-2 |
| | | component (B) |
| 40 | SH3_B | Spherical harmonic level-2 |
| | | component (B) |
| 41 | SH3_B | Spherical harmonic level-3 |
| | | component (B) |
| 42 | SH3_B | Spherical harmonic level-3 |
| | | component (B) |
| 43 | SH3_B | Spherical harmonic level-3 |
| | | component (B) |
| 44 | SH3_B | Spherical harmonic level-3 |
| | | component (B) |
| 45 | SH3_B | Spherical harmonic level-3 |
| | | component (B) |
| 46 | SH3_B | Spherical harmonic level-3 |
| | | component (B) |
| 47 | SH3_B | Spherical harmonic level-3 |
| | | component (B) |

vuh_rsh_attribute_index may indicate the index of spherical harmonic coefficients containing a DC component and/or an AC component. For example, it may indicate the index of spherical harmonic coefficients expressed in the RGB color space. Alternatively, it may indicate the index of spherical harmonic coefficients expressed in the YUV color space.

Referring to Table 12, for vuh_rsh_attribute_index, an index from 0 to 47 may be assigned depending on the combination of the level (0-3) of the spherical harmonic coefficients and the RGB (YUV) channel.

However, the disclosed embodiment is merely an example, and the index of the spherical harmonic attribute information may be defined differently.

The above-described index may be used to indicate information about at least one parameter among the 3DGS Gaussian parameters. The index information may be expressed as a fixed n bits. Here, n may be a natural number greater than 0.

Table 13 below shows an example of a 3DGS unit payload.

TABLE 13

Descriptor

3DGS_unit_payload(numBytesIn3DGSPayload){
if ( vuh_unit_type == 3DGS_PVD ∥ vuh_unit_type == 3DGS_OVD ∥ vuh_unit_type
== 3DGS_SVD ∥ vuh_unit_type == 3DGS_RVD ∥ vuh_unit_type ==
3DGS_SHVD) {
video_sub_bitstream(numBytesIn3DGSPayload)
}

Referring to Table 13, when the 3DGS unit payload is encoded and transmitted, the video_sub_bistream may be encoded and transmitted.

The video_sub_bistream may include a video unit stream encoded using a video codec.

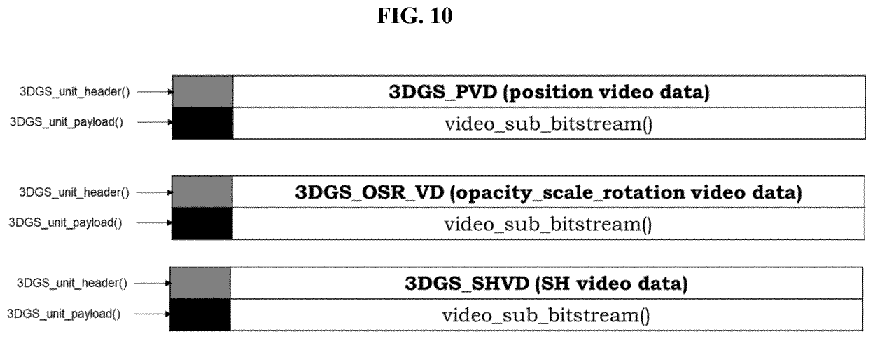

FIG. 10 is a diagram illustrating, as an embodiment according to the present disclosure, a 3DGS encoding stream structure in a case where 2D images are grouped.

When processing 2D images in groups as in the above-described FIG. 7, the 3DGS bitstream for transmitting Gaussian parameters may include 3D Gaussian splatting unit sets as in FIG. 10.

A 3DGS unit set may include one or more 3DGS units. A 3DGS unit may include a 3DGS unit header and/or a 3DGS unit payload as shown in Table 6 above.

A 3DGS unit type may be defined, for example, as shown in Table 14 below.

Table 14 below shows an example of a 3DGS unit type.

TABLE 14

| vuh_{—} | | | |
|---|---|---|---|
| unit_{—} | | | |
| type | Identifier | 3DGS unit type | Description |
| 0 | V3C_VPS | 3DGS parameter set | 3DGS level |
| | | | parameters |
| 1 | 3DGS_PVD | Position video data | Position information |
| 2 | 3DGS_{—} | Opacity Scale | Opacity Scale |
| | OSRVD | Rotation video data | Rotation information |
| 3 | 3DGS_SHVD | Spherical harmonic | Spherical harmonic |
| | | video data | information |
| 4 . . . | _RSVD | Reserved | — |
| 31 | | | |

Referring to Table 14, when vuh_unit_type is 0, the identifier may be set to V3C_VPS, and the 3DGS unit type may be defined as a 3DGS parameter set. This may mean a 3DGS level parameter.

Referring to Table 14, when vuh_unit_type is 1, the identifier may be set to 3DGS_PVD, and the 3DGS unit type may be defined as position video data (PVD). PVD may indicate position information in the 3D space of 3D Gaussian splatting.

Referring to Table 14, when vuh_unit_type is 2, the identifier may be set to 3DGS_OSRVD, and the 3DGS unit type may be defined as opacity scale rotation video data (OSRVD). OSRVD may indicate at least one of opacity information, scale information, and rotation information of 3D Gaussian splatting.

Referring to Table 14, when vuh_unit_type is 3, the identifier may be set to 3DGS_SHVD, and the 3DGS unit type may be defined as spherical harmonic video data (SHVD). SHVD may indicate spherical harmonic coefficients for expressing color values. For example, the spherical harmonic coefficients may be information for expressing color values according to 48 viewpoints and may include 3 DC spherical harmonic coefficients and 45 AC spherical harmonic coefficients.

However, the disclosed embodiment is merely an example, and the 3DGS unit type may be defined differently.

Table 15 below shows an example of a 3DGS unit header.

TABLE 15

| | Descriptor |
|---|---|
| 3DGS_unit_header( ) { | |
| vuh_unit_type | u(n) |
| if ( vuh_unit_type == 3DGS_PVD ∥ vuh_unit_type == 3DGS_OSR_VD ∥ | |
| vuh_unit_type == 3DGS_SHVD) { | |
| } | |
| if (vuh_unit_type == 3DGS_PVD) { | |
| vuh_pos_attribute_index | u(n) |
| } | |
| if (vuh_unit_type == 3DGS_SVD) { | |
| vuh_opacity_scale_rotation_attribute_index | u(n) |
| } | |
| if (vuh_unit_type == 3DGS_SHVD) { | |
| vuh_rsh_attribute_index | u(n) |
| } | |

Referring to Table 15, when the 3DGS_unit_header is encoded and transmitted, vuh_unit_type may be encoded and transmitted. vuh_unit_type may be defined as in Table 14 described above. Since it is the same as described in Table 14, a detailed explanation is omitted here.

Referring to Table 15, when vuh_unit_type is 3DGS_PVD, vuh_pos_attribute_index may be encoded and transmitted.

Referring to Table 15, when vuh_unit_type is 3DGS_SVD, vuh_opacity_scale_rotation_attribute_index may be encoded and transmitted.

Referring to Table 15, when vuh_unit_type is 3DGS_SHVD, vuh_rsh_attribute_index may be encoded and transmitted.

However, the disclosed embodiment is merely an example, and the 3DGS unit header may be defined differently.

Meanwhile, the index vuh_pos_attribute_index of the position attribute information included in the position video data (PVD) is as examined with reference to Table 9 described above, and the index vuh_rsh_attribute_index of the spherical harmonic attribute information included in the spherical harmonic video data (SHVD) is as examined with reference to Table 12 described above.

At least one index vuh_opacity_scale_rotation_attribute_index of opacity information, scale information, and rotation information included in opacity scale rotation video data (OSRVD) may be defined as in Table 16 below.

Table 16 below shows an example of the index vuh_opacity_scale_rotation_attribute_index of attribute information.

TABLE 16

| opacity_scale_rotation_{—} | | |
|---|---|---|
| attribute_index | Identifier | Attribute type |
| 0 | Opacity | Opacity information |
| 1 | Scale_X | Scale X components |
| 2 | Scale_Y | Scale Y components |
| 3 | Scale_Z | Scale Z components |
| 4 | Rotation_X | Rotation X components |
| 5 | Rotation_Y | Rotation Y components |
| 6 | Rotation_Z | Rotation Z components |
| 7 | Rotation_W | Rotation W components |

Referring to Table 16, when vuh_opacity_scale_rotation_attribute_index is 0, the identifier may be set to Opacity, and vuh_opacity_scale_rotation_attribute_index may indicate opacity information of the 3D space of 3D Gaussian splatting.

Referring to Table 16, when vuh_opacity_scale_rotation_attribute_index is 1, the identifier may be set to Scale_X, and vuh_opacity_scale_rotation_attribute_index may indicate scale information of the 3D space of 3D Gaussian splatting.

Referring to Table 16, when vuh_opacity_scale_rotation_attribute_index is 2, the identifier may be set to Scale_Y, and vuh_opacity_scale_rotation_attribute_index may indicate the scale information of the 3D space of 3D Gaussian splatting.

Referring to Table 16, when vuh_opacity_scale_rotation_attribute_index is 3, the identifier may be set to Scale_Z, and vuh_opacity_scale_rotation_attribute_index may indicate the scale information of the 3D space of 3D Gaussian splatting.

Referring to Table 16, when vuh_opacity_scale_rotation_attribute_index is 4, the identifier may be set to Rotation_X, and vuh_opacity_scale_rotation_attribute_index may indicate rotation information in the 3D space of 3D Gaussian splatting.

Referring to Table 16, when vuh_opacity_scale_rotation_attribute_index is 5, the identifier may be set to Rotation_Y, and vuh_opacity_scale_rotation_attribute_index may indicate rotation information in the 3D space of 3D Gaussian splatting.

Referring to Table 16, when vuh_opacity_scale_rotation_attribute_index is 6, the identifier may be set to Rotation_Z, and vuh_opacity_scale_rotation_attribute_index may indicate rotation information in the 3D space of 3D Gaussian splatting.

Referring to Table 16, when vuh_opacity_scale_rotation_attribute_index is 7, the identifier may be set to Rotation_W, and vuh_opacity_scale_rotation_attribute_index may indicate rotation information in the three-dimensional space of 3D Gaussian splatting.

However, the disclosed embodiment is merely an example, and the index of the attribute information may be defined differently.

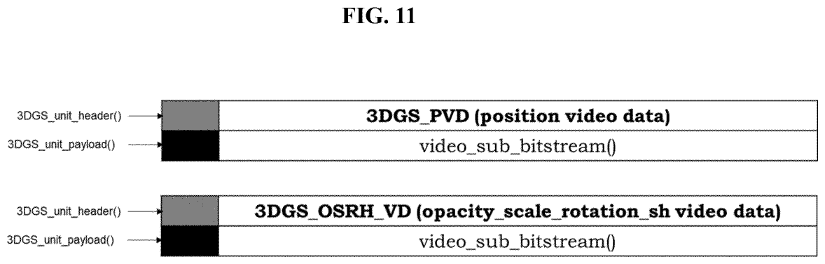

FIG. 11 is a diagram illustrating, as an embodiment according to the present disclosure, a 3DGS encoding stream structure in a case where 2D images are grouped.

When processing 2D images in groups as in the above-described FIG. 7, the 3DGS bitstream for transmitting Gaussian parameters may include 3D Gaussian splatting unit sets as in FIG. 11.

A 3DGS unit set may include one or more 3DGS units. A 3DGS unit may include a 3DGS unit header and/or a 3DGS unit payload as shown in Table 6 above.

A 3DGS unit type may be defined, for example, as shown in Table 17 below.

Table 17 below shows an example of a 3DGS unit type.

TABLE 17

| vuh_{—} | | | |
|---|---|---|---|
| unit_{—} | | | |
| type | Identifier | 3DGS unit type | Description |
| 0 | V3C_VPS | 3DGS parameter set | 3DGS level parameters |
| 1 | 3DGS_PVD | Position video data | Position information |
| 2 | 3DGS_{—} | Opacity Scale | Opacity Scale |
| | OSRSHVD | Rotation Spherical | Rotation Spherical |
| | | Harmonic video data | Harmonic information |
| 3 . . . 31 | _RSVD | Reserved | — |

Referring to Table 17, when vuh_unit_type is 0, the identifier can be set to V3C_VPS, and the 3DGS unit type may be defined as a 3DGS parameter set. This may mean a 3DGS level parameter.

Referring to Table 17, when vuh_unit_type is 1, the identifier may be set to 3DGS_PVD, and the 3DGS unit type may be defined as position video data (PVD). PVD may indicate position information in the 3D space of 3D Gaussian splatting.

Referring to Table 17, when vuh_unit_type is 2, the identifier may be set to 3DGS_OSRSHVD, and the 3DGS unit type may be defined as opacity scale rotation spherical harmonic video data (OSRSHVD). OSRVD may indicate at least one of opacity information, scale information, rotation information, or spherical harmonic coefficients of 3D Gaussian splatting.

Referring to Table 17, when vuh_unit_type is 3, the identifier may be set to 3DGS_SHVD, and the 3DGS unit type may be defined as spherical harmonic video data (SHVD). The SHVD may indicate spherical harmonic coefficients for representing color values. For example, the spherical harmonic coefficients may be information for representing color values at 48 viewpoints and may include three DC spherical harmonic coefficients and 45 AC spherical harmonic coefficients.

However, the disclosed embodiment is merely an example, and the 3DGS unit type may be defined differently.

Table 18 below shows an example of a 3DGS unit header.

TABLE 18

| | Descriptor |
|---|---|
| 3DGS_unit_header( ) { | |
| vuh_unit_type | u(n) |
| if ( vuh_unit_type == 3DGS_PVD ∥ vuh_unit_type == 3DGS_OSR_VD ∥ | |
| vuh_unit_type == 3DGS_SHVD) { | |
| } | |
| if (vuh_unit_type == 3DGS_PVD) { | |
| vuh_pos_attribute_index | u(n) |
| } | |
| if (vuh_unit_type == 3DGS_SVD) { | |
| vuh_opacity_scale_rotation_sh_attribute_index | u(n) |
| } | |

Referring to Table 18, when the 3DGS_unit_header is encoded and transmitted, vuh_unit_type may also be encoded and transmitted. vuh_unit_type may be defined as in Table 17 described above. As described in Table 17, a detailed description thereof will be omitted here.

Referring to Table 18, when vuh_unit_type is 3DGS_PVD, vuh_pos_attribute_index may be encoded and transmitted.

Referring to Table 18, when vuh_unit_type is 3DGS_SVD, vuh_opacity_scale_rotation_sh_attribute_index may be encoded and transmitted.

However, the disclosed embodiment is merely an example, and the 3DGS unit header may be defined differently.

Meanwhile, the index vuh_pos_attribute_index of the position attribute information included in the position video data (PVD) is as described with reference to Table 9 described above.

The index vuh_opacity_scale_rotation_sh_attribute_index of at least one of the opacity information, scale information, rotation information, and spherical harmonic coefficients included in the opacity scale rotation spherical harmonic video data (OSRSHVD) may be defined as in Table 19 below.

Table 19 below shows an example of the index vuh_opacity_scale_rotation_sh_attribute_index of attribute information.

TABLE 19

| opacity_scale_rotation_{—} | | |
|---|---|---|
| sh_attribute_index | Identifier | Attribute type |
| 0 | Opacity | Opacity information |
| 1 | Scale_X | Scale X components |
| 2 | Scale_Y | Scale Y components |
| 3 | Scale_Z | Scale Z components |
| 4 | Rotation_X | Rotation X components |
| 5 | Rotation_Y | Rotation Y components |
| 6 | Rotation_Z | Rotation Z components |
| 7 | Rotation_W | Rotation W components |
| 8 | SH0_R | Spherical harmonic level-0 |
| | | component (R) |
| 9 | SH0_G | Spherical harmonic level-0 |
| | | component (G) |
| 10 | SH0_B | Spherical harmonic level-0 |
| | | component (B) |
| . . . | . . . | . . . |
| 53 | SH0_B | Spherical harmonic level-3 |
| | | component (B) |
| 53 | SH0_B | Spherical harmonic level-3 |
| | | component (B) |
| 54 | SH0_B | Spherical harmonic level-3 |
| | | component (B) |
| 55 | SH0_B | Spherical harmonic level-3 |
| | | component (B) |

Referring to Table 18, when vuh_opacity_scale_rotation_sh_attribute_index is 0, the identifier may be set to Opacity, and vuh_opacity_scale_rotation_sh_attribute_index may indicate opacity information of the 3D space of 3D Gaussian splatting.

Referring to Table 18, when vuh_opacity_scale_rotation_sh_attribute_index is 1, the identifier may be set to Scale_X, and vuh_opacity_scale_rotation_sh_attribute_index may indicate scale information of the 3D space of 3D Gaussian splatting.

Referring to Table 18, when vuh_opacity_scale_rotation_sh_attribute_index is 2, the identifier may be set to Scale_Y, and vuh_opacity_scale_rotation_sh_attribute_index may indicate the scale information of the 3D space of 3D Gaussian splatting.

Referring to Table 18, when vuh_opacity_scale_rotation_sh_attribute_index is 3, the identifier may be set to Scale_Z, and vuh_opacity_scale_rotation_sh_attribute_index may indicate the scale information of the 3D space of 3D Gaussian splatting.

Referring to Table 18, when vuh_opacity_scale_rotation_sh_attribute_index is 4, the identifier may be set to Rotation_X, and vuh_opacity_scale_rotation_sh_attribute_index may indicate rotation information of the 3D space of 3D Gaussian splatting.

Referring to Table 18, when vuh_opacity_scale_rotation_sh_attribute_index is 5, the identifier may be set to Rotation_Y, and vuh_opacity_scale_rotation_sh_attribute_index may indicate rotation information of the 3D space of 3D Gaussian splatting.

Referring to Table 18, when vuh_opacity_scale_rotation_sh_attribute_index is 6, the identifier may be set to Rotation_Z, and vuh_opacity_scale_rotation_sh_attribute_index may indicate rotation information of the 3D space of 3D Gaussian splatting.

Referring to Table 18, when vuh_opacity_scale_rotation_sh_attribute_index is 7, the identifier may be set to Rotation_W, and vuh_opacity_scale_rotation_sh_attribute_index may indicate rotation information of the 3D space of 3D Gaussian splatting.

Additionally, vuh_opacity_scale_rotation_sh_attribute_index may indicate the index of a spherical harmonic coefficients that includes DC components and/or AC components. For example, it may indicate the index of a spherical harmonic coefficient expressed in an RGB color space. Or, it may indicate the index of a spherical harmonic coefficient expressed in a YUV color space. Depending on the combination of the level (0-3) of the spherical harmonic coefficient and the RGB (YUV) channel, for example, an index from 8 to 55 may be assigned.

However, the described embodiment is merely an example, and the index of the spherical harmonic coefficient may be defined differently.

Meanwhile, according to one embodiment of the present disclosure, encoding and decoding may be performed in a 4:4:4 format for position information, scale information, rotation information, and spherical harmonic coefficients having information of three or more channels.

When encoding/decoding information in the 4:4:4 format as described above, for example, encoding/decoding of vuh_pos_attribute_index may be omitted.

When encoding/decoding information in the 4:4:4 format as described above, for example, vuh_opacity_scale_rotation_sh_attribute_index may be defined as shown in Table 20 below.

Table 20 below shows an example of the index vuh_opacity_scale_rotation_sh_attribute_index of attribute information.

TABLE 20

| opacity_scale_rotation_{—} | | |
|---|---|---|
| sh_attribute_index | Identifier | Attribute type |
| 0 | Opacity | Opacity information |
| 1 | Scale_XYZ | Scale XYZ components |
| 2 | Rotation_XYZ | Rotation XYZ components |
| 3 | Rotation_W | Rotation W components |
| 4 | SH0_RGB | Spherical harmonic level-0 |
| | | component (RGB) |
| 5 | SH1_RGB | Spherical harmonic level-1 |
| | | component (RGB) |
| 6 | SH1_RGB | Spherical harmonic level-1 |
| | | component (RGB) |
| 7 | SH1_RGB | Spherical harmonic level-1 |
| | | component (RGB) |
| 8 | SH2_RGB | Spherical harmonic level-2 |
| | | component (RGB) |
| 9 | SH2_RGB | Spherical harmonic level-2 |
| | | component (RGB) |
| 10 | SH2_RGB | Spherical harmonic level-2 |
| | | component (RGB) |
| 11 | SH2_RGB | Spherical harmonic level-2 |
| | | component (RGB) |
| 12 | SH2_RGB | Spherical harmonic level-2 |
| | | component (RGB) |
| 13 | SH3_RGB | Spherical harmonic level-3 |
| | | component (RGB) |
| 14 | SH3_RGB | Spherical harmonic level-3 |
| | | component (RGB) |
| 15 | SH3_RGB | Spherical harmonic level-3 |
| | | component (RGB) |
| 16 | SH3_RGB | Spherical harmonic level-3 |
| | | component (RGB) |
| 17 | SH3_RGB | Spherical harmonic level-3 |
| | | component (RGB) |
| 18 | SH3_RGB | Spherical harmonic level-3 |
| | | component (RGB) |
| 19 | SH3_RGB | Spherical harmonic level-3 |
| | | component (RGB) |

Referring to Table 20, when vuh_opacity_scale_rotation_sh_attribute_index is 0, the identifier may be set to Opacity, and vuh_opacity_scale_rotation_sh_attribute_index can indicate opacity information of the 3D space of 3D Gaussian splatting.

Referring to Table 20, when vuh_opacity_scale_rotation_sh_attribute_index is 1, the identifier may be set to Scale_XYZ, and vuh_opacity_scale_rotation_sh_attribute_index may indicate scale information of the 3D space of 3D Gaussian splatting.

Referring to Table 20, when vuh_opacity_scale_rotation_sh_attribute_index is 2, the identifier may be set to Rotation_XYZ, and vuh_opacity_scale_rotation_sh_attribute_index may indicate rotation information of the 3D space of 3D Gaussian splatting.

Referring to Table 20, when vuh_opacity_scale_rotation_sh_attribute_index is 3, the identifier may be set to Rotation_W, and vuh_opacity_scale_rotation_sh_attribute_index may indicate rotation information of the 3D space of 3D Gaussian splatting.

Additionally, vuh_opacity_scale_rotation_sh_attribute_index may indicate the index of spherical harmonic coefficients that includes DC components and/or AC components. For example, it may indicate the index of spherical harmonic coefficients expressed in an RGB color space. Or, it can indicate the index of spherical harmonic coefficients expressed in a YUV color space. Depending on the combination of the level (0-3) of the spherical harmonic coefficients and the RGB (YUV) channel, for example, an index from 4 to 19 may be assigned.

Meanwhile, information related to the bit depth and minimum and/or maximum values of the parameters used in the 3D Gaussian parameter quantization and dequantization process may be encoded/decoded in the unit header.

Tables 21 and 22 below illustrate examples of information related to the bit depth and minimum and/or maximum values of the parameters encoded and transmitted in the 3DGS unit header.

TABLE 21

| | Descriptor |
|---|---|
| 3DGS_unit_header( ) | |
| vuh_unit_type | u(n) |
| if ( vuh_unit_type == 3DGS_PVD ∥ vuh_unit_type == 3DGS_OVD ∥ | |
| vuh_unit_type == 3DGS_SVD ∥ vuh_unit_type == 3DGS_RVD ∥ vuh_unit_type | |
| == 3DGS_SHVD) { | |
| } | |
| if (vuh_unit_type == 3DGS_PVD) { | |
| vuh_pos_attribute_index | u(n) |
| vuh_pos_bitdepth | u(n) |
| vuh_pos_min | fl(n) |
| vuh_pos_max | fl(n) |
| if (vuh_unit_type == 3DGS_SVD) { | |
| vuh_scale_attribute_index | u(n) |
| vuh_scale_bitdepth | u(n) |
| vuh_scale_min | fl(n) |
| vuh_scale_max | fl(n) |
| } | |

TABLE 22

| | Descriptor |
|---|---|
| 3DGS_unit_header( ) | |
| vuh_unit_type | u(n) |
| if ( vuh_unit_type == 3DGS_PVD ∥ vuh_unit_type == 3DGS_OVD ∥ | |
| vuh_unit_type == 3DGS_SVD ∥ vuh_unit_type == 3DGS_RVD ∥ vuh_unit_type | |
| == 3DGS_SHVD) { | |
| } | |
| if (vuh_unit_type == 3DGS_RVD) { | |
| vuh_rotation_attribute_index | u(n) |
| vuh_rotation_bitdepth | u(n) |
| vuh_rotation_min | fl(n) |
| vuh_rotation_max | fl(n) |
| if (vuh_unit_type == 3DGS_SHVD) { | |
| vuh_rsh_attribute_index | u(n) |
| vuh_rsh_bitdepth | u(n) |
| vuh_rsh_min | fl(n) |
| vuh_rsh_max | fl(n) |
| } | |

However, the disclosed embodiment is merely an example, and information related to the bit depth and the minimum and/or maximum values of the parameters used in the 3D Gaussian parameter quantization and dequantization process may be encoded/decoded in a different manner.

For example, bit depth information for each Gaussian parameter and information related to minimum and/or maximum values for each parameter channel may be defined and encoded/decoded in VPS, SPS, PPS, APS, etc.

For example, a 3DGS parameter set may be defined and encoded/decoded within a unit of the corresponding unit type.

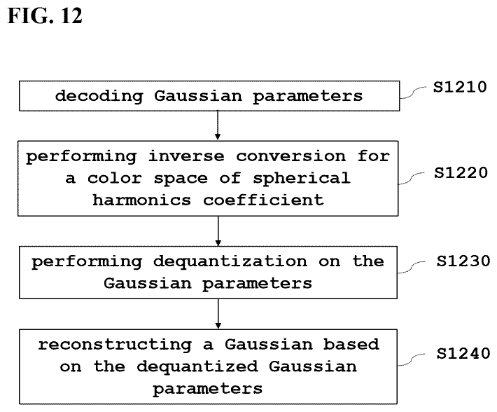

FIG. 12 is a flowchart for explaining a method of decoding Gaussian parameters based on two-dimensional (2D) image structuring according to an embodiment of the present disclosure.

Referring to FIG. 12, Gaussian parameters are decoded from a bitstream S1210.

According to one embodiment of the present disclosure, Gaussian parameters may be structured and decoded as a two-dimensional image.

During the decoding process, Gaussian parameters in the form of a one-dimensional array may be reconstructed based on predefined information and/or transmitted information.

The structuring and/or grouping method of Gaussian parameters may be understood to be applied equally in the encoding/decoding method, and as detailed with reference to FIG. 2, a detailed description thereof will be omitted here.

The SEI message for receiving Gaussian parameters may be understood to be applied equally in both encoding and decoding methods, as discussed with reference to Tables 1 through 5. Therefore, a detailed description thereof will be omitted here to avoid duplication.

Furthermore, the structure of the encoding and decoding streams for receiving Gaussian parameters may be understood to be applied equally in both encoding and decoding methods, as discussed with reference to FIGS. 9 through 11 and Tables 6 through 21. Therefore, a detailed description thereof will be omitted here to avoid duplication.

Referring to FIG. 12, an inverse conversion on a color space of at least one spherical harmonic coefficient included in the decoded Gaussian parameters is performed S1220.

The decoded Gaussian parameters may include one or more spherical harmonic coefficients. The spherical harmonic coefficients may be expressed as spherical harmonic coefficients. The spherical harmonic coefficients may be expressed in the YUV color space.

According to one embodiment of the present disclosure, the spherical harmonic coefficients expressed in the YUV color space may be inversely converted to be expressed in the RGB color space.

The inverse conversion may be performed using a conversion matrix.

For example, the above conversion matrix may be expressed as the following Mathematical equation 11.

$$[ \begin{matrix}R \\ G \\ B\end{matrix} ] = [ \begin{matrix}1 & 0 & 1.13983 \\ 1 & - 0.39465 & - 0.5806 \\ 1 & 2.03211 & 0\end{matrix} ] [ \begin{matrix}Y \\ U \\ V\end{matrix} ] \qquad [ Mathematical equation 11 ]$$

The above Mathematical equation 11 may be an equation defined in the BT. 470 document.

According to one embodiment of the present disclosure, information regarding whether a color space is converted and the converted color space may be decoded from a bitstream.

Meanwhile, according to one embodiment of the present disclosure, additional reordering may be performed on the spherical harmonic coefficients prior to inverse conversion. For example, as illustrated in FIG. 6 discussed above, if they are arranged and stored by being divided for each channel in a YUV color space, they may be reordered to be sequentially arranged for each channel in the YUV color space, as illustrated in FIG. 5. Afterwards, an inverse conversion into an RGB color space may be performed on the reordered coefficients. As illustrated in FIG. 4, the inverse-converted coefficients may be sequentially arranged for each channel in the RGB color space. Additionally, as illustrated in FIG. 3, a reordering process may be performed so that the spherical harmonic coefficients are arranged separately for each channel in the RGB color space.

When using spherical harmonic coefficients in the YUV color space, additional truncation may be performed on some spherical harmonic coefficients. During the decoding process, the truncated UV coefficients may be set to a predefined value of 0. During the decoding process, the truncated UV coefficients may be set to a predefined value of 0 and converted from the YUV color space to the RGB color space.

Referring to FIG. 12, dequantization is performed on the Gaussian parameters S1230.

According to one embodiment of the present disclosure, dequantization may be performed based on the minimum and maximum values of Gaussian for each Gaussian parameter.

Dequantization may be performed by calculating the following Mathematical equation 12.

$${x}_{recon} = {x}_{q} \times \frac{{x}_{max} - {x}_{min}}{L - 1} + {x}_{min} \qquad [ Mathematical equation 12 ]$$

Here, xₘₐₓ may represent the maximum value of the Gaussian parameter x calculated for all Gaussians, xₘᵢₙ may represent the minimum value of the Gaussian parameter x calculated for all Gaussians, L may represent the number of integer bits represented by the quantization result, x_{q} may represent the quantization value, and x_{recon} may represent the dequantization value.

The above variable x is merely an example for convenience of explanation, and it may be understood that it applies to all Gaussian parameters.

As a result of performing dequantization by calculating Mathematical equation 12, the Gaussian parameter may be expressed as a 32-bit floating point.

As a result of performing dequantization by calculating Mathematical equation 12, the Gaussian parameters may be expressed as 32-bit floating-point numbers.

For example, parameter X in the position information may be expressed as 32-bit floating-point numbers.

For example, parameter Y in the position information may be expressed as 32-bit floating-point numbers.

For example, parameter Z in the position information may be expressed as 32-bit floating-point numbers.

For example, parameter W in the rotation information may be expressed as 32-bit floating-point numbers.

For example, parameter Sₓ in the scale information may be expressed as 32-bit floating-point numbers.

When quantization is performed based on minimum and maximum values, information regarding the minimum and maximum values for each Gaussian parameter for performing dequantization may be decoded from a bitstream.

Meanwhile, according to one embodiment of the present disclosure, the same dequantization method may be applied to each Gaussian parameter, or different dequantization methods may be applied.

For example, dequantization on position information may be performed by calculating Mathematical equation 13.

$$\begin{matrix}\hat{x} = 256 {f}^{- 1} ( {x}_{q} , {b}_{pos} ) + {x}_{min} \\ \hat{y} = 256 {f}^{- 1} ( {y}_{q} , {b}_{pos} ) + {y}_{min} \\ \hat{z} = 256 {f}^{- 1} ( {z}_{q} , {b}_{pos} ) + {z}_{min}\end{matrix} \qquad [ Mathematical equation 13 ]$$

Here, bₚₒₛ may represent a quantization bit for position information, xₘᵢₙ may represent the minimum value of the Gaussian parameter x calculated for all Gaussians, yₘᵢₙ may represent the minimum value of the Gaussian parameter y calculated for all Gaussians, and zₘᵢₙ may represent the minimum value of the Gaussian parameter z calculated for all Gaussians. Here, bₚₒₛ may be an integer greater than 0.

For example, dequantization on opacity information may be performed by calculating Mathematical equation 14.

$$= {Mf}^{- 1} ( {op}_{q} , {b}_{op} ) - N \qquad [ Mathematical equation 14 ]$$

Here, bₒₚ may represent the quantization bits for opacity information. Here, N and M may be integers greater than 0. For example, N may be 7, and M may be 25.

For example, dequantization on scale information may be performed by calculating Mathematical equation 15.

$$\hat{s} = {Qf}^{- 1} ( {s}_{q} , {b}_{s} ) - P \qquad [ Mathematical equation 15 ]$$

Here, bₑ may represent the quantization bits for scale information. Here, P and Q may be integers greater than 0. For example, P may be 26, and Q may be 30.

For example, dequantization on rotation information may be performed by calculating Mathematical equation 16.

$$\hat{r} = {Vf}^{- 1} ( {r}_{q} , {b}_{rot} ) - C \qquad [ Mathematical equation 16 ]$$

Here, r may represent the normalized rotation information, and bᵣoₜ may represent the quantization bits for the rotation information. Here, C and V may be integers greater than 0. For example, C may be 1, and V may be 2.

For example, dequantization of the spherical harmonic coefficients may be performed by calculating Mathematical equation 17.

$$\hat{c} = 2 Δ ( {f}^{- 1} ( {c}_{q} , {b}_{s h} ) - \frac{1}{2} ) \qquad [ Mathematical equation 17 ]$$

In Mathematical equation 17, c may represent the spherical harmonic coefficients expressed in the YUV color space, and bₛₕ may represent the quantization bits for the spherical harmonic coefficients. Here, bₛₕ and Δ may be integers greater than 0. For example, they may be 4.

Meanwhile, the function f⁻¹ used in Mathematical equations 13 to 17 described above may be defined as Mathematical equation 18 below.

$${f}^{- 1} ( x , b ) = \frac{x}{{2}^{b}} \qquad [ Mathematical equation 18 ]$$

Here, the independent variables of the function f may vary depending on the Gaussian parameters being dequantized.

Meanwhile, dequantization of Gaussian parameters may also be performed as described in the following example.

For example, dequantization may be performed on each RGB, YUV, or YCbCr channel by calculating the above Mathematical equation 12 based on the minimum and maximum values calculated for each RGB, YUV, or YCbCr channel for the DC components corresponding to level 0 among the spherical harmonic coefficients represented in the RGB, YUV, or YCbCr color space. The minimum and maximum values for each channel for the DC components may be decoded from the bitstream.

For example, dequantization may be performed on each channel of RGB, YUV, or YCbCr by calculating the above Mathematical equation 12 based on the minimum and maximum values calculated by integrating all RGB or YUV channels for the DC components corresponding to level 0 among the spherical harmonic coefficients represented in the RGB, YUV, or YCbCr color space. The minimum and maximum values for each channel for the DC components may be decoded from the bitstream.

For example, for AC components corresponding to levels greater than level 0 among the spherical harmonic coefficients represented in an RGB, YUV, or YCbCr color space, dequantization may be performed for each channel of the RGB, YUV, YCbCr color space by calculating the above Mathematical equation 12 based on minimum and maximum values calculated for each channel of the RGB, YUV, or YCbCr color space. The minimum and maximum values for each channel of the AC components may be decoded from the bitstream.

For example, for AC components corresponding to levels greater than level 0 among the spherical harmonic coefficients represented in an RGB, YUV, or YCbCr color space, dequantization may be performed for each channel of the RGB, YUV, or YCbCr color space by calculating the above Mathematical equation 12 based on minimum and maximum values calculated by integrating all channels of the RGB, YUV, or YCbCr color space. The minimum and maximum values for each channel of the AC components may be decoded from the bitstream.

For example, for the spherical harmonic coefficients represented in an RGB, YUV, or YCbCr color space, dequantization on each channel of the RGB, YUV, or YCbCr color space may be performed by calculating the above Mathematical equation 12 based on minimum and maximum values calculated by integrating all channels. In this embodiment, a single minimum and a single maximum value may be applied to the spherical harmonic coefficients, and the minimum and maximum values may be decoded from the bitstream.

For example, dequantization with a fixed normalization range may be performed by calculating the above Mathematical equation 9 for AC components corresponding to levels greater than level 0 among the spherical harmonic coefficients expressed in the RGB or YUV or YCbCr color space. In this embodiment, information on the fixed normalization range value may be decoded from the bitstream. Alternatively, the same range value as that used in a preprocessing stage may be defined in a post-processing.

For example, dequantization on each of 3D spatial scale information components X, Y, and Z of a Gaussian may be performed by calculating the above Mathematical equation 12 based on minimum and maximum values calculated by integrating the X, Y, and Z components of the 3D spatial scale information.

For example, dequantization on each of 3D spatial rotation information components X, Y, Z, and W of a Gaussian may be performed by calculating the above Mathematical equation 12 based on minimum and maximum values calculated by integrating X, Y, Z, and W components of the 3D spatial rotation information. Before the quantization process, normalization may be performed for the Gaussian rotation information, and in particular, a sign of a parameter W may be inverted to make it positive.

For example, dequantization on each of 3D spatial position information components X, Y, and Z of a Gaussian may be performed by calculating the above Mathematical equation 12 based on minimum and maximum values calculated by integrating the X, Y, and Z components of the 3D spatial position information.

For example, for DC components corresponding to level 0 among the spherical harmonic coefficients represented in an RGB, YUV, or YCbCr color space, dequantization may be performed for each color channel (R, G, B or Y, U, V, or Y, Cb, Cr) by calculating the above Mathematical equation 12 after calculating at least one of a minimum value and a maximum value for each channel.

In this case, if only the minimum value is calculated, the maximum value may be derived by adding a predefined offset value to the minimum value. Conversely, if only the maximum value is calculated, the minimum value may be derived by subtracting the offset value from the maximum value.

At least one of the minimum value, maximum value, and offset value for the DC component may be decoded from the bitstream for each channel.

For example, for AC components corresponding to levels greater than level 0 among the spherical harmonic coefficients represented in an RGB, YUV, or YCbCr color space, dequantization may be performed for each color channel (R, G, B or Y, U, V or Y, Cb, Cr) by calculating the above Mathematical equation 12 after calculating at least one of a minimum value and a maximum value for each color channel.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum value, the maximum value, and the offset value for the AC components may be decoded from the bitstream for each channel.

For example, for DC components corresponding to level 0 among the spherical harmonic coefficients represented in an RGB, YUV, or YCbCr color space, dequantization may be performed for each color channel (R, G, B or Y, U, V or Y, Cb, Cr) by calculating at least one of a minimum value and a maximum value after integrating the color channels, and using at least one of the calculated minimum or maximum values according to the above Mathematical equation 12.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum values, the maximum value, or the offset value for the DC components may be decoded from the bitstream for each channel.

For example, for AC components corresponding to levels greater than level 0 among the spherical harmonic coefficients represented in an RGB, YUV, or YCbCr color space, dequantization may be performed for each color channel (R, G, B or Y, U, V or Y, Cb, Cr) according to the above Mathematical equation 12 by calculating at least one of a minimum value and a maximum value after integrating the color channels, and using at least one of the calculated minimum or maximum values.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum values, the maximum value, or the offset value for the AC components may be decoded from the bitstream for each channel.

For example, dequantization may be performed on each of the 3D spatial scale information X, Y, and Z according to the above Mathematical equation 12 by using at least one of the minimum or maximum values calculated by integrating the 3D spatial scale information X, Y, and Z components of Gaussian.

In this case, when only the minimum value is calculated, the maximum value may be derived by adding a predefined offset value to the minimum value. Conversely, when only the maximum value is calculated, the minimum value may be derived by subtracting the offset value from the maximum value.

At least one of the minimum value, maximum value, or offset value for the above 3D spatial scale information may be decoded from the bitstream for each channel.

For example, dequantization may be performed on each of the 3D spatial rotation information X, Y, Z, and W according to the above Mathematical equation 12 by using at least one of the minimum or maximum values calculated by integrating the 3D spatial rotation information X, Y, Z, and W components of Gaussian. Prior to the quantization process, normalization may be performed on the Gaussian rotation information, and in particular, the sign of parameter W may be changed to a positive value.

At least one of the minimum value, maximum value, or offset value for the above 3D spatial rotation information may be decoded from the bitstream for each channel.

Referring to FIG. 2, a Gaussian is reconstructed based on the dequantized Gaussian parameters S1240.

The Gaussian may be reconstructed in 3D space based on the dequantized Gaussian parameters reconstructed to real values.

According to the method of the present disclosure, by encoding/decoding the Gaussian parameters in the form of a structured 2D image, the initial Gaussian may be reconstructed using only a small amount of data. The reconstructed Gaussian may be reconstructed with the same or visually similar quality as the input initial Gaussian.

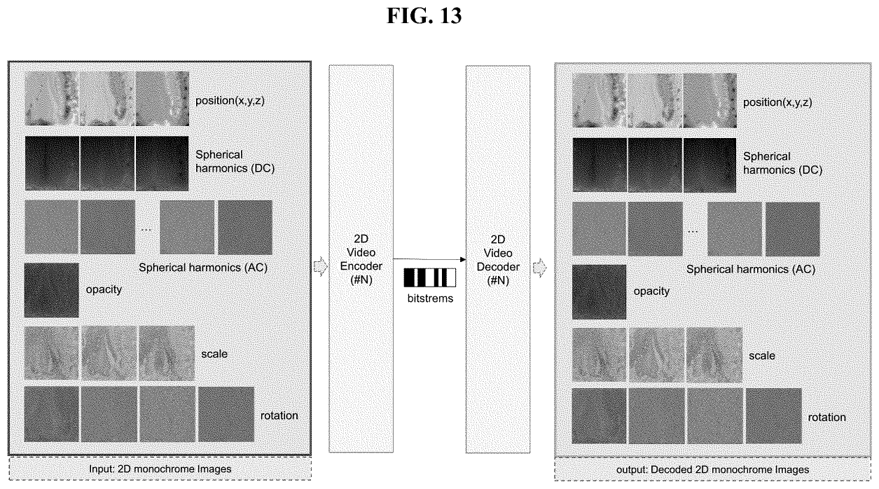

FIG. 13 is a diagram illustrating, according to the present disclosure, an embodiment of encoding and decoding structured 2D images.

Gaussian parameters may be structured into a 2D image and encoded/decoded.

Referring to FIG. 13, the 2D image generated as a result of structuring the Gaussian parameters may be input to a video codec for encoding/decoding. The structuring process has been described in detail with reference to FIG. 2, so a detailed description will be omitted here.

Referring to FIG. 13, the 2D image being encoded/decoded may have a single format.

The embodiment described with reference to FIG. 13 is merely an example, and different results may be derived.

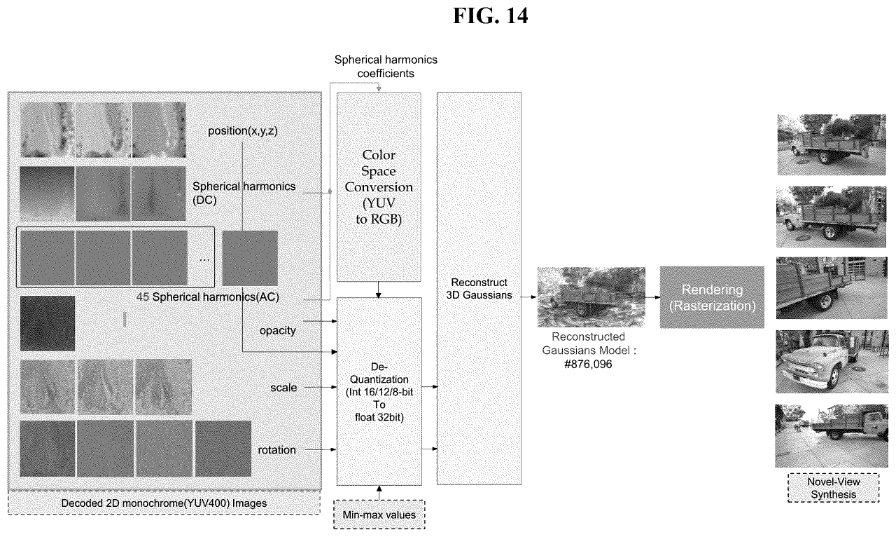

FIG. 14 is a diagram illustrating, according to the present disclosure, an embodiment of reconstructing Gaussian parameters and generating arbitrary viewpoints based on structured 2D images.

Referring to FIG. 14, Gaussian parameters may be decoded into a structured 2D image. The decoded image may have a single format.

Referring to FIG. 14, Gaussian parameters in the form of a 1D array may be reconstructed from a structured 2D image.

Referring to FIG. 14, quantization may be performed on Gaussian parameters. Among the Gaussian parameters, spherical harmonic coefficients may be quantized after conversion. Quantization may be performed by calculating the minimum and maximum values for each Gaussian parameter.

Referring to FIG. 14, a 3D Gaussian may be reconstructed based on the quantized Gaussian parameters.

Referring to FIG. 14, rendering may be performed on a reconstructed 3D Gaussian. Rendering may be performed by projecting the 3D Gaussian onto a 2D image. In this case, loss may be calculated by comparing the projected image with the ground truth image, and for example, the L1 loss and D-SSIM loss functions may be used. Based on the calculated loss value, optimization may be performed by adaptively controlling the Gaussian parameters.

Additionally, during the Gaussian parameter optimization process, the number of Gaussians may be increased or decreased to accurately represent the scene or remove unnecessary elements.

The optimized Gaussians are projected into a two-dimensional image, and tile rasterization may be performed on the projected image. Alpha blending (α-blending) is then performed in depth order, starting with the Gaussian closest to the screen, to generate the final rendered image. Based on the final rendered image, arbitrary viewpoints may be generated.

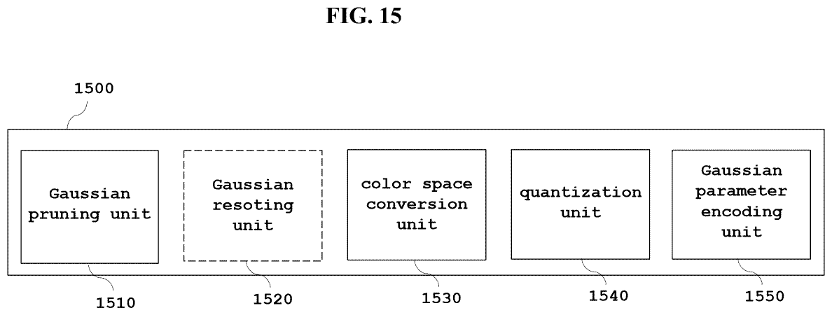

FIG. 15 is a block diagram of an encoding apparatus 1500 for performing a method of encoding Gaussian parameters based on 2D image structuring according to an embodiment of the present disclosure.

The Gaussian pruning unit 1510 may perform operation S210. Since this has been described in detail with reference to FIG. 2, a detailed description thereof will be omitted here to avoid redundant explanation.

The Gaussian sorting unit 1520 may perform operation S220. Since this has been described in detail with reference to FIG. 2, a detailed description thereof will be omitted here to avoid redundant explanation.

The color space conversion unit 1530 may perform the operation of S230. Since this has been discussed in detail with reference to FIG. 2, a detailed description thereof will be omitted here to avoid redundancy.

The quantization unit 1540 may perform the operation of S240. Since this has been discussed in detail with reference to FIG. 2, a detailed description thereof will be omitted here to avoid redundancy.

The Gaussian parameter encoding unit 1550 may perform the operation of S250. Since it has been examined in detail with reference to FIG. 2, a detailed description will be omitted here to avoid redundant explanation.

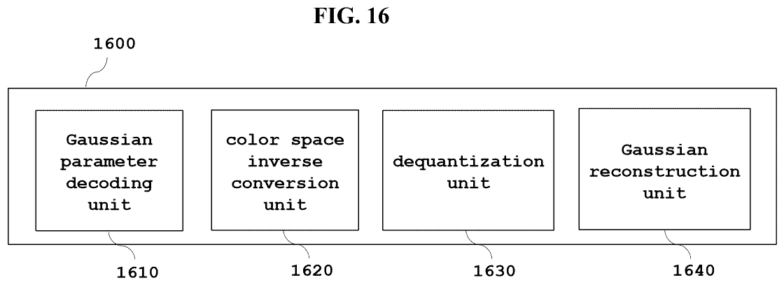

FIG. 16 is a block diagram of a decoding apparatus 1600 for performing a method of decoding Gaussian parameters based on 2D image structuring according to an embodiment of the present disclosure.

The Gaussian parameter decoding unit 1610 may perform the operation of S1210. Since this has been discussed in detail with reference to FIG. 12, a detailed description thereof will be omitted here to avoid redundancy.

The color space inverse conversion unit 1620 may perform the operation of S1220. Since this has been discussed in detail with reference to FIG. 12, a detailed description thereof will be omitted here to avoid redundancy.

The dequantization unit 1630 may perform the operation of S1230. Since this has been discussed in detail with reference to FIG. 12, a detailed description thereof will be omitted here to avoid redundancy.

The Gaussian reconstruction unit 1640 may perform the operation of S1240. Since this has been discussed in detail with reference to FIG. 12, a detailed description thereof will be omitted here to avoid redundancy.

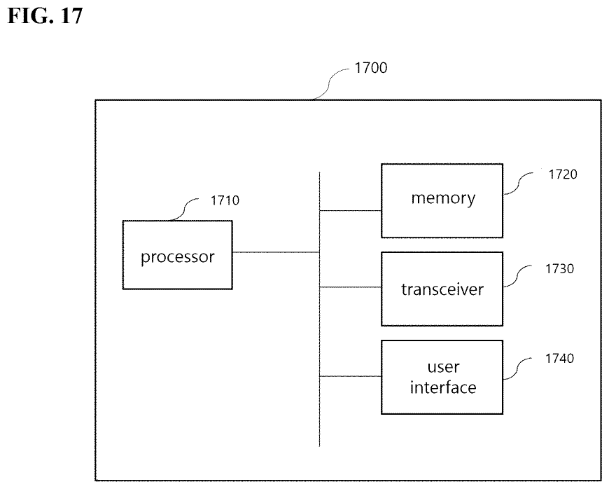

FIG. 17 is a diagram illustrating an apparatus for performing a method of encoding and decoding Gaussian parameters based on 2D image structuring according to the present disclosure.

The apparatus 1700 may include one or more processors 1710, one or more memories 1720, one or more transceivers 1730, one or more user interfaces 1740, etc. The memory 1720 may be included in the processor 1710 or may be configured separately. The memory 1720 may store instructions that cause the apparatus 1700 to perform operations when executed by the processor 1710. The transceiver 1730 may transmit and/or receive signals, data, etc. that the apparatus 1700 exchanges with other entities. The user interface 1740 may receive an input of the user for the apparatus 1700 or provide an output of the apparatus 1700 to the user. Among the components of the apparatus 1700, components other than the processor 1710 and the memory 1720 may not be included in some cases, and other components not shown in FIG. 17 may be included in the apparatus 1700.

The processor 1710 may be configured to cause the apparatus 1700 to perform operations of the device according to various examples of the present disclosure. Although not illustrated in FIG. 17, the processor 1710 may be configured as a set of modules each performing a function. The modules may be configured in the form of hardware and/or software.

The processor 1710 of the encoding apparatus 1700 can generally support/perform operations such as performing pruning on Gaussians; sorting Gaussian parameters of the pruned Gaussians; performing conversion on a color space of at least one spherical harmonic coefficient included in the sorted Gaussian parameters; performing quantization on the Gaussian parameters; and encoding the quantized Gaussian parameter into a bitstream.

Here, the Gaussian parameters are encoded in the form of a structured two-dimensional image.

The processor 1710 of the decoding apparatus 1700 can generally support/perform operations such as decoding Gaussian parameters from a bitstream; performing an inverse conversion on a color space of at least one spherical harmonic coefficient included in the decoded Gaussian parameters; performing dequantization on the Gaussian parameters; and reconstructing a Gaussian based on the dequantized Gaussian parameters.

Here, the Gaussian parameters are decoded in the form of a structured two-dimensional image.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as an FPGA, a GPU, other electronic device, or a combination thereof.

At least some of functions or processes described in illustrative embodiments of the present disclosure may be implemented by software and the software may be recorded in a recording medium. A component, a function, and a process described in illustrative embodiments may be implemented by a combination of hardware and software.

A method according to an embodiment of the present disclosure may be implemented by a program which may be performed by a computer and the computer program may be recorded in a variety of recording media such as a magnetic storage medium, an optical reading medium, a digital storage medium, etc.

A variety of technologies described in the present disclosure may be implemented by a digital electronic circuit, computer hardware, firmware, software, or a combination thereof. The technologies may be implemented by a computer program product, that is, a computer program tangibly implemented on an information medium or a computer program processed by a computer program (for example, a machine-readable storage device (for example, a computer-readable medium) or a data processing device) or a data processing device or implemented by a signal propagated to operate a data processing device (for example, a programmable processor, a computer, or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are located at one site or spread across multiple sites and are interconnected by a communication network.

An example of a processor suitable for executing a computer program includes a general-purpose and special-purpose microprocessor and one or more processors of a digital computer. In general, a processor receives an instruction and data in a read-only memory (ROM), a random-access memory (RAM), or both memories. A component of a computer may include at least one processor for executing an instruction and at least one memory device for storing an instruction and data. In addition, a computer may include one or more mass storage devices for storing data, for example, a magnetic disk, a magneto-optical disc, or an optical disc, or may be connected to the mass storage device to receive and/or transmit data. An example of an information medium suitable for implementing a computer program instruction and data includes a semiconductor memory device (for example, a magnetic medium such as a hard disk, a floppy disk, or a magnetic tape), an optical medium such as a compact disc read-only memory (CD-ROM), a digital video disc (DVD), etc., a magneto-optical medium such as a floptical disk, and a ROM, a RAM, a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, the processor device may include a plurality of processors or a processor and a controller. In addition, the processor device may configure a different processing structure like parallel processors. In addition, a computer readable medium means all media which may be accessed by a computer and may include both a computer storage medium and a transmission medium.

The present disclosure includes detailed description of various detailed implementation examples. However, it should be understood that the detailed content does not limit a scope of claims or an invention proposed in the present disclosure and describes features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from claims and a spirit and a scope of equivalents thereto.

Accordingly, the present disclosure includes all other replacements, modifications and changes belonging to the following claim.

What is claimed is:

1. A method for decoding Gaussian parameters, the method comprises:
decoding Gaussian parameters from a bitstream;
performing an inverse conversion on a color space of at least one spherical harmonic coefficient included in the decoded Gaussian parameters;
performing dequantization on the Gaussian parameters; and
reconstructing a Gaussian based on the dequantized Gaussian parameters,
wherein the Gaussian parameters are decoded in the form of a structured two-dimensional (2D) image.

2. The method of claim 1, wherein a reordering of at least one spherical harmonic coefficient included in the decoded Gaussian parameters is further performed, and
wherein the inverse conversion is performed on the reordered at least one spherical harmonic coefficient.

3. The method of claim 1, wherein the inverse conversion is performed by setting a truncated UV coefficient among the at least one spherical harmonic coefficient to a predefined value of 0.

4. The method of claim 1, wherein the dequantization is performed by applying different dequantization methods for each Gaussian parameter.

5. The method of claim 1, wherein the dequantization on the at least one spherical harmonic coefficient included in the Gaussian parameters is performed based on the minimum and maximum values calculated for each channel for any one of the RGB, YUV, or YCbCr color spaces.

6. The method of claim 1, wherein the dequantization on the at least one spherical harmonic coefficient included in the Gaussian parameters is performed based on the minimum and maximum values calculated by integrating all channels for any one of the RGB, YUV, or YCbCr color spaces.

7. The method of claim 1, wherein the structuring is performed by storing the Gaussian parameters as pixel values of a 2D image based on a predetermined scanning order, and
wherein the predetermined scanning order includes at least one of a raster scan order, a reverse raster scan order, a zig-zag order, and a reverse zig-zag order.

8. The method of claim 1, wherein the structured 2D image is grouped into at least one group.

9. The method of claim 1, wherein at least one of information among a number of groups, the arrangement order of the 2D images within a group, and the Gaussian parameter type for the 2D images is decoded from the bitstream.

10. The method of claim 8, wherein based on the structured 2D images being grouped into a first group including structured 2D images for position information, a second group including structured 2D images for spherical harmonic coefficients, and a third group including structured 2D images for opacity information, unit type information is decoded from the bitstream in a Gaussian parameter unit header,
wherein based on a value of the unit type information indicating a first type related to the position information, an index indicating the position information is decoded from the bitstream,
wherein based on the value of the unit type information indicating a second type related to the spherical harmonic coefficients, an index indicating the spherical harmonic coefficients is decoded from the bitstream, and
wherein based on the value of the unit type information indicating a third type related to the opacity information, rotation information, and scale information, an index indicating at least one of the opacity information, rotation information, and scale information is decoded from the bitstream.

11. A method for encoding Gaussian parameters, the method comprises:
performing pruning on Gaussians;
sorting Gaussian parameters of the pruned Gaussians; performing conversion on a color space of at least one spherical harmonic coefficient included in the sorted Gaussian parameters;
performing quantization on the Gaussian parameters; and
encoding the quantized Gaussian parameters into a bitstream,
wherein the Gaussian parameters are decoded in the form of a structured two-dimensional (2D) image.

12. The method of claim 11, wherein the quantization is performed by applying different quantization methods for each Gaussian parameter.

13. The method of claim 11, wherein the quantization on the at least one spherical harmonic coefficient included in the Gaussian parameters is performed based on the minimum and maximum values calculated for each channel for any one of the RGB, YUV, or YCbCr color spaces.

14. The method of claim 11, wherein the quantization on the at least one spherical harmonic coefficient included in the Gaussian parameters is performed based on the minimum and maximum values calculated by integrating all channels for any one of the RGB, YUV, or YCbCr color spaces.

15. The method of claim 11, wherein the structuring is performed by storing the Gaussian parameters as pixel values of a 2D image based on a predetermined scanning order, and
wherein the predetermined scanning order includes at least one of a raster scan order, a reverse raster scan order, a zig-zag order, and a reverse zig-zag order.

16. The method of claim 11, wherein the structured 2D image is grouped into at least one group.

17. The method of claim 16, wherein based on the structured 2D images being grouped into a first group including a structured 2D image for position information, a second group including a structured 2D image for spherical harmonic coefficients, and a third group including a structured 2D image for opacity information, rotation information, and scale information, unit type information is encoded into the bitstream and transmitted in a Gaussian parameter unit header,
wherein based on a value of the unit type information indicating a first type related to the position information, an index indicating the position information is encoded into the bitstream and transmitted,
wherein based on the value of the unit type information indicating a second type related to the spherical harmonic coefficients, an index indicating the spherical harmonic coefficients is encoded into the bitstream and transmitted, and
wherein based on the value of the unit type information indicating a third type related to the opacity information, rotation information, and scale information, an index indicating at least one of the opacity information, rotation information, and scale information is encoded into the bitstream and transmitted.

18. A recording medium for storing a bitstream generated by a method for encoding Gaussian parameters, the method comprises:
performing pruning on Gaussians;
sorting Gaussian parameters of the pruned Gaussians;
performing conversion on a color space of at least one spherical harmonic coefficient included in the sorted Gaussian parameters;
performing quantization on the Gaussian parameters; and
encoding the quantized Gaussian parameters into the bitstream,
wherein the Gaussian parameters are encoded in the form of a structured two-dimensional (2D) image.
